(19) United States
(12) Patent Application Publication
(10) Pub. No.: US 2026/0064743 A1
(43) Pub. Date: Mar. 5, 2026

(54) Systems and Methods for Prompt-Based Query Generation for Diverse Retrieval

(71) Applicant: Google LLC, Mountain View, CA (US)

(72) Inventors: Zhuyun Dai, Sunnyvale, CA (US); Yuzhe Zhao, San Francisco, CA (US); Ji Ma, London (GB); Yi Luan, Kirkland, WA (US); Jianmo Ni, Santa Clara, CA (US); Jing Lu, Jersey City, NJ (US); Anton Danchev Bakalov, Jersey City, NJ (US); Kelvin Gu, Redwood City, CA (US); Keith Brendan Hall, Montclair, NJ (US); Ming-Wei Chang, Redmond, WA (US)

(21) Appl. No.: 19/107,238

(22) PCT Filed: Sep. 21, 2023
(86) PCT No.: PCT/US2023/033324

§ 371 Date: Feb. 27, 2025

Related U.S. Application Data
(60) Provisional application No. 63/376,508, filed on Sep. 21, 2022.

(51) Int. Cl. G06F 16/334

(52) U.S. Cl. CPC G06F 16/3344

(57) ABSTRACT

An example method for prompt-based query generation is provided. The method includes receiving, by a computing device, at least two prompts associated with a retrieval task to be performed on a corpus of documents associated with the task. The method includes applying, based on the at least two prompts and the corpus of documents, a large language model to generate a synthetic training dataset comprising a plurality of query-document pairs, wherein each query-document pair comprises a synthetically generated query and a document from the corpus of documents. The method includes training, on the plurality of query−document pairs from the synthetic training dataset, a document retrieval model to take an input query associated with the retrieval task and predict an output document retrieved from the corpus of documents. The method includes providing, by the computing device, the trained document retrieval model.

### CROSS-REFERENCE TO RELATED APPLICATIONS/INCORPORATION BY REFERENCE

This application claims priority to U.S. Provisional Patent Application No. 63/376,508, filed on Sep. 21, 2022, which is hereby incorporated by reference in its entirety.

### BACKGROUND

Natural language processing tasks such as question answering, claim verification, and so forth, involve retrieving knowledge from a large collection of documents containing millions or billions of candidates. Training of machine learning models to perform such tasks involves a large dataset of annotated query-document pairs for each task.

### SUMMARY

There are many diverse and unique retrieval tasks targeting different scenarios. For example, different question answering (QA) tasks often have distinct distributions of queries. Also, for example, retrieval tasks are not limited to question answering tasks, even though retrieval systems are generally trained on question answering data. For example, the task may involve retrieving an entity that is mentioned in a query, or to find evidence that either supports or disputes a given statement. Unlike other retrieval systems, neural retrieval systems are generally trained on question answering data. Neural retrieval systems may not perform well on many tasks due to data scarcity, since a significant amount of annotated query-document pairs are needed to train the neural retrieval systems for each task. Also, for example, dual encoder models generally depend on more data than cross-attention counterparts, and typically require tens of thousands of labeled examples for the in-batch softmax loss function to be effective. Therefore, there is a technical problem of training neural retrieval systems on a variety of tasks with few labeled examples.

As described herein, a prompt-based query generation, filtering and retriever training, also referred to as a PROMPTAGATOR system or PROMPTAGATOR, can harness the power of large language models (LLMs) with the efficiency of standard dual encoders. PROMPTAGATOR can create task-specific dual encoders by generating large quantities of task-specific synthetic data. PROMPTAGATOR is able to achieve significant improvement in retrieval (e.g., without a re-ranker) by using just two to eight examples for prompts. PROMPTAGATOR also significantly reduces the need for heavily engineered retrieval architectures.

In one aspect, a computer-implemented method for prompt-based query generation is provided. The method includes receiving, by a computing device, at least two prompts associated with a retrieval task to be performed on a corpus of documents associated with the task. The method also includes applying, based on the at least two prompts and the corpus of documents, a large language model to generate a synthetic training dataset comprising a plurality of query-document pairs, wherein each query-document pair comprises a synthetically generated query and a document from the corpus of documents. The method additionally includes training, on the plurality of query-document pairs from the synthetic training dataset, a document retrieval model to take an input query associated with the retrieval task and predict an output document retrieved from the corpus of documents. The method further includes providing, by the computing device, the trained document retrieval model.

In a second aspect, a computing device for prompt-based query generation is provided. The computing device includes one or more processors and data storage. The data storage has stored thereon computer-executable instructions that, when executed by one or more processors, cause the computing device to carry out functions. The functions include: receiving, by a computing device, at least two prompts associated with a retrieval task to be performed on a corpus of documents associated with the task; applying, based on the at least two prompts and the corpus of documents, a large language model to generate a synthetic training dataset comprising a plurality of query-document pairs, wherein each query-document pair comprises a synthetically generated query and a document from the corpus of documents; training, on the plurality of query-document pairs from the synthetic training dataset, a document retrieval model to take an input query associated with the retrieval task and predict an output document retrieved from the corpus of documents; and providing, by the computing device, the trained document retrieval model.

In a third aspect, a computer program for prompt-based query generation is provided. The computer program includes instructions that, when executed by a computer, cause the computer to carry out functions. The functions include: receiving, by a computing device, at least two prompts associated with a retrieval task to be performed on a corpus of documents associated with the task; applying, based on the at least two prompts and the corpus of documents, a large language model to generate a synthetic training dataset comprising a plurality of query-document pairs, wherein each query-document pair comprises a synthetically generated query and a document from the corpus of documents; training, on the plurality of query-document pairs from the synthetic training dataset, a document retrieval model to take an input query associated with the retrieval task and predict an output document retrieved from the corpus of documents; and providing, by the computing device, the trained document retrieval model.

In a fourth aspect, an article of manufacture for prompt-based query generation is provided. The article of manufacture includes one or more computer readable media having computer-readable instructions stored thereon that, when executed by one or more processors of a computing device, cause the computing device to carry out functions. The functions include: receiving, by a computing device, at least two prompts associated with a retrieval task to be performed on a corpus of documents associated with the task; applying, based on the at least two prompts and the corpus of documents, a large language model to generate a synthetic training dataset comprising a plurality of query-document pairs, wherein each query-document pair comprises a synthetically generated query and a document from the corpus of documents; training, on the plurality of query-document pairs from the synthetic training dataset, a document retrieval model to take an input query associated with the retrieval task and predict an output document retrieved from the corpus of documents; and providing, by the computing device, the trained document retrieval model.

In a fifth aspect, a system for prompt-based query generation is provided. The system includes: means for receiving, by a computing device, at least two prompts associated with a retrieval task to be performed on a corpus of documents associated with the task; means for applying, based on the at least two prompts and the corpus of documents, a large language model to generate a synthetic training dataset comprising a plurality of query-document pairs, wherein each query-document pair comprises a synthetically generated query and a document from the corpus of documents; means for training, on the plurality of query-document pairs from the synthetic training dataset, a document retrieval model to take an input query associated with the retrieval task and predict an output document retrieved from the corpus of documents; and means for providing, by the computing device, the trained document retrieval model.

In a sixth aspect, a computer-implemented method of applying a trained document retrieval model is provided. The method includes receiving, by a computing device, an input query associated with a retrieval task to be performed on a corpus of documents associated with the task. The method also includes predicting, by the trained document retrieval model, a document from the corpus of documents, wherein the document has a high relevance to the input query, the document retrieval model having been trained on a plurality of query-document pairs from a synthetic training dataset, the synthetic training dataset having been generated by a large language model based on at least two prompts associated with the retrieval task. The method additionally includes providing, by the computing device and in response to the input query, the predicted document.

In a seventh aspect, a computing device for applying a trained document retrieval model is provided. The computing device includes one or more processors and data storage. The data storage has stored thereon computer-executable instructions that, when executed by one or more processors, cause the computing device to carry out functions. The functions include: receiving, by a computing device, an input query associated with a retrieval task to be performed on a corpus of documents associated with the task; predicting, by the trained document retrieval model, a document from the corpus of documents, wherein the document has a high relevance to the input query, the document retrieval model having been trained on a plurality of query-document pairs from a synthetic training dataset, the synthetic training dataset having been generated by a large language model based on at least two prompts associated with the retrieval task; and providing, by the computing device and in response to the input query, the predicted document.

In an eighth aspect, a computer program for applying a trained document retrieval model is provided. The computer program includes instructions that, when executed by a computer, cause the computer to carry out functions. The functions include: receiving, by a computing device, an input query associated with a retrieval task to be performed on a corpus of documents associated with the task; predicting, by the trained document retrieval model, a document from the corpus of documents, wherein the document has a high relevance to the input query, the document retrieval model having been trained on a plurality of query-document pairs from a synthetic training dataset, the synthetic training dataset having been generated by a large language model based on at least two prompts associated with the retrieval task; and providing, by the computing device and in response to the input query, the predicted document.

In a ninth aspect, an article of manufacture for applying a trained document retrieval model is provided. The article of manufacture includes one or more computer readable media having computer-readable instructions stored thereon that, when executed by one or more processors of a computing device, cause the computing device to carry out functions. The functions include: receiving, by a computing device, an input query associated with a retrieval task to be performed on a corpus of documents associated with the task; predicting, by the trained document retrieval model, a document from the corpus of documents, wherein the document has a high relevance to the input query, the document retrieval model having been trained on a plurality of query-document pairs from a synthetic training dataset, the synthetic training dataset having been generated by a large language model based on at least two prompts associated with the retrieval task; and providing, by the computing device and in response to the input query, the predicted document.

In a tenth aspect, a system for applying a trained document retrieval model is provided. The system includes means for receiving, by a computing device, an input query associated with a retrieval task to be performed on a corpus of documents associated with the task; means for predicting, by the trained document retrieval model, a document from the corpus of documents, wherein the document has a high relevance to the input query, the document retrieval model having been trained on a plurality of query-document pairs from a synthetic training dataset, the synthetic training dataset having been generated by a large language model based on at least two prompts associated with the retrieval task; and means for providing, by the computing device and in response to the input query, the predicted document.

The foregoing summary is illustrative only and is not intended to be in any way limiting. In addition to the illustrative aspects, embodiments, and features described above, further aspects, embodiments, and features will become apparent by reference to the figures and the following detailed description and the accompanying drawings.

### BRIEF DESCRIPTION OF THE FIGURES

FIG. 1 is a diagram illustrating an overview of the training aspects of a document retrieval model, in accordance with example embodiments.

FIG. 2 is a diagram illustrating an example query generation model and an example document retrieval model, in accordance with example embodiments.

FIG. 3 illustrates example prompt templates for various datasets, in accordance with example embodiments.

FIG. 4 illustrates example comparisons of different retriever frameworks, in accordance with example embodiments.

FIG. 5 illustrates example comparisons of different retriever frameworks and retriever with reranker frameworks, in accordance with example embodiments.

FIG. 6A is a bar chart illustrating an impact of round trip filtering, in accordance with example embodiments.

FIG. 6B is a graph illustrating human annotated examples, in accordance with example embodiments.

FIG. 6C illustrates results of an example ablation on query generation model, in accordance with example embodiments.

FIG. 7 illustrates an impact of different Finetuned LAnguage Net (FLAN) versions, in accordance with example embodiments.

FIG. 8 illustrates an impact of selected examples on model output, in accordance with example embodiments.

FIG. 9A illustrates example top first word distribution on queries generated from different models in the Argumentation Analysis (ArguAna) dataset, in accordance with example embodiments.

FIG. 9B illustrates example top first word distribution on queries generated from different models in the ArguAna dataset, in accordance with example embodiments.

FIG. 9C illustrates example top first word distribution on queries generated from different models in the ArguAna dataset, in accordance with example embodiments.

FIG. 9D illustrates example top first word distribution on queries generated from different models in the ArguAna dataset, in accordance with example embodiments.

FIG. 10A illustrates example few-shot and zero-shot generated queries randomly sampled from various datasets, in accordance with example embodiments.

FIG. 10B illustrates example few-shot and zero-shot generated queries randomly sampled from various datasets, in accordance with example embodiments.

FIG. 10C illustrates example few-shot and zero-shot generated queries randomly sampled from various datasets, in accordance with example embodiments.

FIG. 11 illustrates a table with an average query length for various datasets, in accordance with example embodiments.

FIG. 12 is a diagram illustrating training and inference phases of a machine learning model, in accordance with example embodiments.

FIG. 13 depicts a distributed computing architecture, in accordance with example embodiments.

FIG. 14 is a block diagram of a computing device, in accordance with example embodiments.

FIG. 15 depicts a network of computing clusters arranged as a cloud-based server system, in accordance with example embodiments.

FIG. 16 is a flowchart of a method, in accordance with example embodiments.

FIG. 17 is a flowchart of another method, in accordance with example embodiments.

### DETAILED DESCRIPTION

This application relates, in one aspect, to resolving a data scarcity issue while maintaining efficiency of small dual encoders, by harnessing the power of large language models (LLM). To address the data scarcity issue, PROMPTAGATOR combines prompting with large language models as a query generator without fine-tuning. Because of the use of large language models, PROMPTAGATOR can generate good queries without any training data from natural questions. PROMPTAGATOR can use a few prompts that enable few-shot retrieval, resulting in a significant improvement with just two to eight examples for each task, by inputting these new examples in the prompt. PROMPTAGATOR can amplify the power of these few examples by creating task-specific prompting, instead of using them to directly train a dual encoder. A large number of training data comprising pairs of query and document can be generated. After query generation, the task-specific noisy paired data can be used to train task-specific dual encoders. A second iteration for training may be performed by filtering the noisy paired data to generate a clean dataset, and using the clean dataset to train the task-specific dual encoders.

Neural retrieval models such as dual encoders can search over a large collection of documents containing millions to billions of passages. However, BEnchmarking Information Retrieval (BEIR) demonstrates that it may be challenging for neural retrievers to perform well on a wide variety of retrieval tasks that lack dedicated training data. To address this problem, some approaches focus on transferring knowledge from high-resource question answering (QA) datasets and propose architectures that possess good inductive biases, such as models that allow fine-grained token-level interaction (e.g., Contextualized Late interaction over BERT (ColBERT) and SParse Lexical AnD Expansion (SPLADE)) which are associated with higher inference costs.

Data augmentation via synthetic query generation generally involves question generators that are learned from high-resource QA datasets, and often cannot generalize well to new retrieval tasks. Some approaches leverage synthetic question generation on the target corpus to alleviate the issue of data scarcity. While effective in improving performance on QA retrieval tasks, one of the limitations of such approaches is that the question-generation models are trained on question answering datasets, so the distribution of questions generated may not match the true query distribution in the target task.

A few-shot LLM query generator described herein can produce good queries without any fine-tuning the model. In fact, synthetically generated data can be strong enough to reduce and/or eliminate the use of annotated query-document pairs from traditional high-resource datasets such as Natural Questions.

To ensure quality of the generated data, a filtering strategy is described using generated data only. The filtering strategy can remove ambiguous, generic, and low-quality questions, and can significantly improve retrieval performance. Note that while an LLM is used to generate training data, the retrieval model at inference time can be any standard size retriever.

Existing approaches on using LLMs do not apply to task-specific few-shot adaptation, and often came with high inference costs. For example, some approaches involve using GPT-3 in dual encoders; however, their embedding dimension is 12,000, which can make the search index footprint and inference cost prohibitively high for many applications. Another existing approach involves prompting LLMs for question generation, but this approach does not use task-specific few-shot prompts for rapid task adaptation. This approach also focuses primarily on models that re-rank top retrievals from an existing retriever, rather than directly adapting the underlying retriever, which can efficiently search over millions or billions of documents.

The approach described herein involves taking into account differences across retrieval tasks (e.g., search intent and query distribution), and proposes a few-shot retrieval evaluation for a dataset (e.g., the BEIR dataset). As described, PROMPTAGATOR is a simplified model for few-shot retrieval that prompts an LLM to generate synthetic task-specific training data. Accordingly, neural retrievers and re-rankers may be trained solely based on a few supervised examples. As illustrated, PROMPTAGATOR with two-to-eight examples, can produce significantly better retrievers than existing models trained on MS MARCO or NQ that have over 500,000 human annotated examples, and utilize more expensive architectures. For example, PROMPTAGATOR can outperform ColBERT v2 and SPLADE v2 on several retrieval tasks that can be tested, while re-ranking can boost results by another five (5) points on standard retrieval evaluation metric.

### Overview System

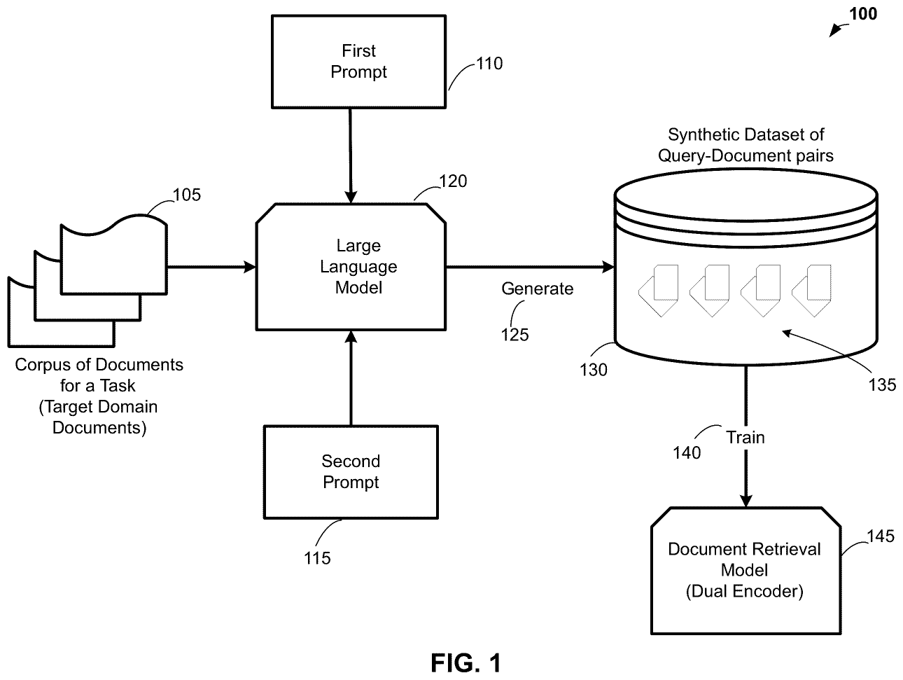

FIG. 1 is a diagram illustrating an overview 100 of the training aspects of a document retrieval model, in accordance with example embodiments. Some embodiments involve receiving at least two prompts (e.g., first prompt 110 and second prompt 115) associated with a retrieval task to be performed on a corpus of documents 105 associated with the task. Some embodiments involve applying, based on the at least two prompts (e.g., first prompt 110 and second prompt 115) and the corpus of documents 105, a LLM 120 to generate (e.g., generate 125) a synthetic training dataset 130 comprising a plurality of query-document pairs 135. Each of the plurality of query-document pairs 135 may include a synthetically generated query and a document from the corpus of documents 105. Some embodiments involve training (e.g., train 140), on the plurality of query-document pairs 135 from the synthetic training dataset 130, a document retrieval model 145 to take an input query associated with the retrieval task and predict an output document retrieved from the corpus of documents 105. Additional details on each of these steps is provided below.

### Task

Described herein is a few-shot retrieval approach for diverse retrieval tasks, where each task is associated with a short description and a few annotated examples to clearly illustrate the search intent. As described herein, for each new retrieval task, the few-shot examples may be input to a large language model (e.g., LLM 120) such as Finetuned LAnguage Net (FLAN). FLAN is a LLM that is not trained on any document retrieval or document-to-query generation tasks. FLAN may be prompted to perform doc-to-query generation (e.g., generate 125). Generally speaking, the few-shot examples ensure that the specific search intent of a particular task is captured. Using this query generator large language model (LLM) 120, a large number of relevant queries may be synthetically generated for any document, yielding abundant data (e.g., plurality of query-document pairs 135 from the synthetic training dataset 130) for training a retriever (e.g., document retrieval model 145), including highly efficient dual encoder models.

Generally speaking, different retrieval tasks may have different search intents; in other words, different definitions of “relevance”. For example, consider tasks to retrieve documents from Wikipedia. The task may be a first task to retrieve entities that are mentioned in the query, or a second task to find evidence that either supports or refutes a given statement. Determining which document is relevant to the query can be very different for each task even if they share the same domain. Moreover, different tasks can have distinct distributions of queries even when their search intents may be similar. For example, some queries can be long compositional questions, while other queries can be short financial questions. The retrieval domain can vary from general webpages to articles from Wikipedia, questions from Quora, or papers for a specific disease.

For illustrative purposes, a few-shot retrieval setting is described for the BEIR benchmark. Given a large corpus (e.g., corpus of documents 105), a retrieval model (e.g., document retrieval model 145) can be configured to find documents that are of high relevance to a provided query q according to a pre-defined notion of relevance. Formally, a retrieval task may be formulated as:

$$T = \{ 𝒟 , Q , I \} \qquad ( Eqn . 1 )$$

where [symbol] ={d₁, d₂, . . . , dₙ} is a large corpus of documents (e.g., corpus of documents 105) for retrieval, [symbol] is a query distribution, and I is an underlying search intent for the task. Depending on the task, [symbol] can be any document collection, such as the web or Wikipedia. The retrieval, [symbol] , also varies across tasks, e.g., short keyword search queries, questions, arguments, etc. In the event I(q, d)=1, this indicates that the search intent of q has been satisfied by the document d. For example, in a question answering task I_{QA} (q, d)=1 indicates that document d answers query q. For the same (q, d) pair, relevance may be either 1 or 0 depending on the search intent. For example, some argument retrieval tasks may seek to retrieve supporting arguments, while others may seek to retrieve counterarguments.

Generally, a target retrieval corpus [symbol] _{T} (e.g., corpus of documents 105 for a particular task) may be given, but the amount of annotated query-document pairs for the new task may be limited. Existing approaches focus on adapting retrievers to a new corpus [symbol] _{T}, but do not account for divergence in queries [symbol] _{T} or intents I_{T}. As described herein, a search intent may be expressed with a short description and very few examples.

### Few-Shot Setting

A human being is generally able to understand a retrieval task by reading a short prompt and going over a few examples. Accordingly, it may be natural to determine whether a few (e.g., 8 or fewer) examples may be sufficient for a machine learning model to learn a task-specific retriever. In this regard, a few-shot retrieval evaluation may be built upon a BEIR heterogeneous retrieval benchmark.

BEIR includes 18 information retrieval datasets across 9 domains, including Bio-Medical, Finance, News, Twitter, Wikipedia, StackExchange, Quora, Scientific, and Miscellaneous. These datasets cover a diverse range of search intents: QA retrieval (question-to-document), duplicate question discovery (question-to-question), fact checking (claim-to-document), and so forth. The original BEIR evaluation used a zero-shot setup, where no queries or relevant query-document pairs from the evaluation datasets could be used for training.

In some aspects, as described herein, BEIR may be modified to the few-shot setting by randomly taking a few (e.g., 2 to 8) in-domain relevant query-document examples as task-specific supervision. Generally, this number of examples is possible to obtain. The examples may be sampled from a development set when it is available. For BEIR tasks which only have a test set, samples from the test data may be used.

### PROMPTAGATOR Model

The PROMPTAGATOR may be configured to transform a few examples into many more examples by prompting an LLM (e.g., LLM 120) to generate more data (e.g., synthetic training dataset 130), instead of using the examples to train a retriever (e.g., document retrieval model 145) directly. In some embodiments, PROMPTAGATOR may include three components: prompt-based query generation, consistency filtering, and retriever training. During prompt-based query generation, a task-specific prompt may be combined with a large language model to produce relevant queries for all documents in [symbol] _{T}. Then, a filtering step may clean the generated data based on round-trip consistency. In some embodiments, a retriever trained only on synthetic data (e.g., plurality of query-document pairs 135 from the synthetic training dataset 130) may be used to filter the synthetic data. Finally, a retriever (e.g., a dual encoder) and a cross-attention reranker may be trained based on the filtered data.

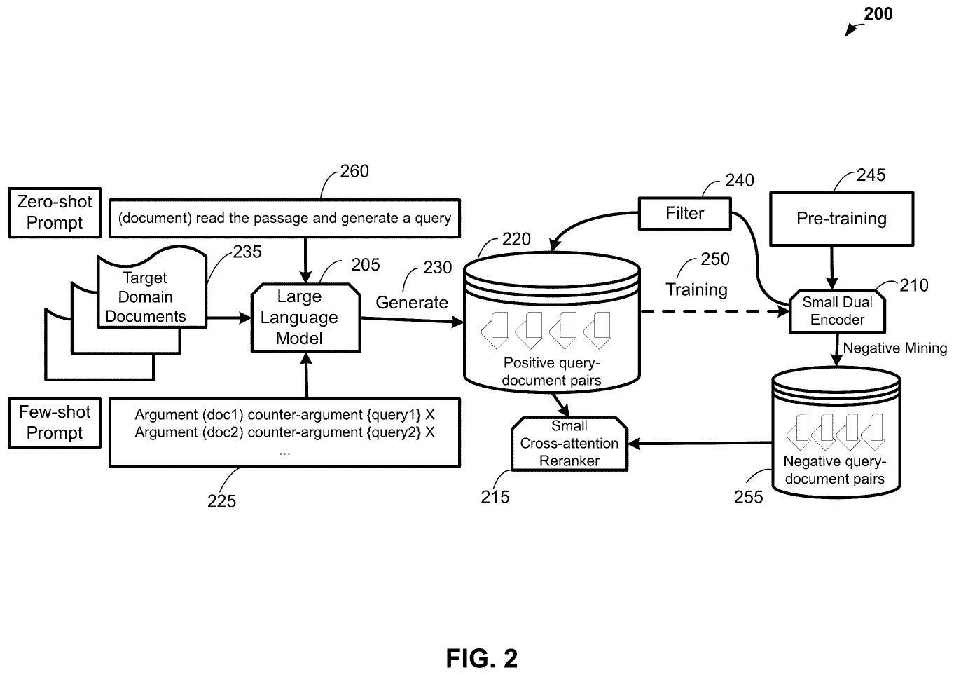

FIG. 2 is a diagram 200 illustrating an example query generation model and an example document retrieval model, in accordance with example embodiments. As described herein, PROMPTAGATOR combines prompting with instruction-tuned large language models (e.g., LLM 205) to form a query generation with much less restriction compared to other models. It can rely on very few examples (e.g., 8 or less) to train retrievers (e.g., dual encoders 210), and can outperform customized designed models. In some embodiments, cross-attention reranker 215 may be a listwise model based on T5. For example, it may receive a list of documents from synthetic data 220 given a query as an input, based on the query-document pairings. Also, each query-document pair may be represented as “Query: {q} Document: {d}” and the pairs may be input into the encoder of a cross-attention reranker 215 (e.g., a T5 model). In some embodiments, a projection layer may be applied on the output encodings of the first token and the output may be used as the ranking score. Also, for example, the model may be optimized using softmax cross entropy loss over a ranking list consisting of a positive (q, d+) pair and sampled negative (q, d⁻) pairs (e.g., 31 sampled negative pairs). Unlike monoT5, which is a pointwise reranker that uses an encoder-decoder model and is trained to generate a relevance label, cross-attention reranker 215 may be a listwise reranker and can directly optimize for ranking performance.

### Prompt-Based Query Generation

In some embodiments, task-specific few-shot examples 225 may be input into the large language model (e.g., LLM 205). LLM 205 may be prompted to perform document-to-query generation 230. More precisely, let {(qᵢ, dᵢ)}^{k} denote the k few-shot examples 225, where each example is a query (qᵢ˜ [symbol] _{T}) and a document relevant to that query (dᵢ ∈ [symbol] _{T}) according to the target task T (I_{T}(qᵢ, dᵢ)=1).

Following FLAN, an instruction-prompt may be applied to LLM 205 with the following string prefix:

$${e}_{d o c} ( {d}_{i} ) \vert {e}_{query} ( {q}_{1} ) \vert … \vert {e}_{d o c} ( {d}_{k} ) \vert {e}_{query} ( {q}_{k} ) \vert {e}_{d o c} ( d ) , \qquad ( Eqn . 2 )$$

where “|” is indicative of a separator token, e_{doc}(d) and e_{query}(q) are task-specific document and query descriptions respectively, and d denotes a new document presented at inference time. In some embodiments, LLM 205 may be prompted to generate counterarguments based on: e_{doc}(d)=“Argument: {d}” and e_{query}=“Counter Argument: {q}”.

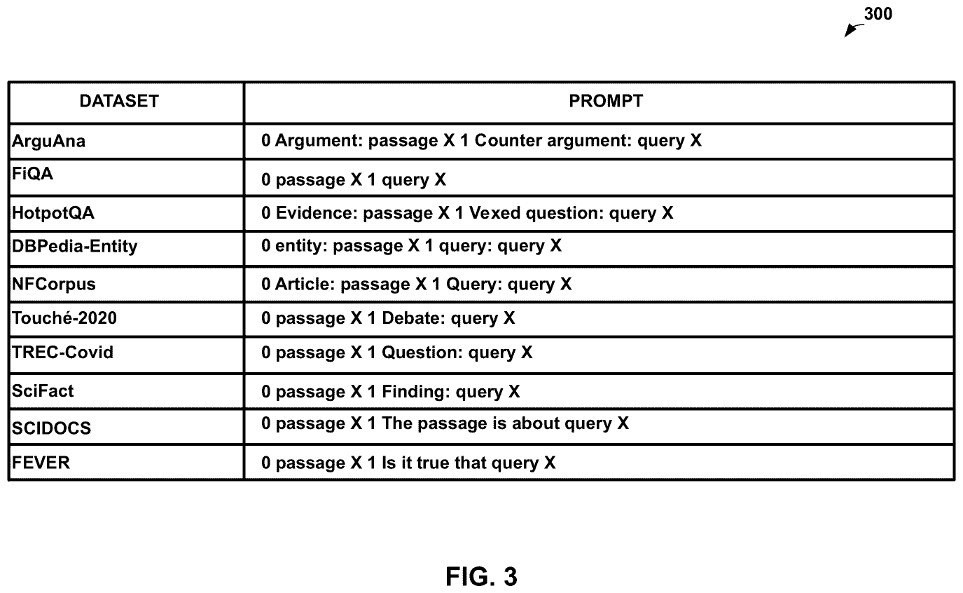

FIG. 3 illustrates example prompt templates 300 for various datasets, in accordance with example embodiments. A full set of example descriptions used in the prompts are illustrated in FIG. 3. The datasets include Argumentation Analysis (ArguAna), Financial Question Answering (FiQA), natural multi-hop Question Answering (HotpotQA), entity search over the database-pedia (DBpedia) knowledge base (DBpedia-Entity), NutritionFacts Corpus (NFCorpus), Touche 2020, Text REtrieval Conference data for Covid (TREC-Covid), Scientific Claims (SciFact), Scientific Documentations (SciDocs), and Fact Extraction and VERification (FEVER).

Referring again to FIG. 2, although LLM 205 may be configured to generate e_{query} (\hat{q}), in some embodiments, a generation failure may be recorded if the query description does not precede the actual query; otherwise, \hat{q} may be accepted and a synthetic relevant example (q, d) may be generated.

In some embodiments, such a prompt may be run on documents from [symbol] _{T} 235 to generate a large set of synthetic (q, d) examples 220, amplifying the information from a few examples (e.g., task-specific few-shot examples 225) into a large synthetic dataset (e.g., synthetic data 220). Generally, the query distribution synthetic dataset (e.g., synthetic data 220) may be designed to be similar to a true task distribution [symbol] _{T} and query-document pairs are designed to convey the true search intent Ir.

In some embodiments, LLM 205 may be a FLAN model, and the query generator may be denoted as p_{FLAN}(q|d). FLAN may be trained on a collection of tasks described via instructions and generally achieves a high zero/few-shot performance on unseen tasks. Some embodiments involve using a 137 billion parameter checkpoint. During prompt engineering, at most 8 examples may be used, and the number may be further reduced if they exceed the input length limit of FLAN. Also, for example, individual queries and documents in the examples may be manually truncated if they are longer than a threshold length. As another example, up to 1 million documents may be randomly sampled from each corpus and 8 questions per document may be generated using sampling-based decoding, and with a temperature parameter at 0.7.

### Round-Trip Filtering Generated Data

In some embodiments, round-trip filtering 240 may be applied to improve the quality of the synthetic dataset 220. Generally speaking, for a synthetic query q generated from a passage d, a desirable synthetic query q should also retrieve its original passage d. In other words, the original d should have high probability under some retriever, p(d|\hat{q}) (the reverse direction of query generation). When such a condition is not achieved, the generated query q may be filtered out.

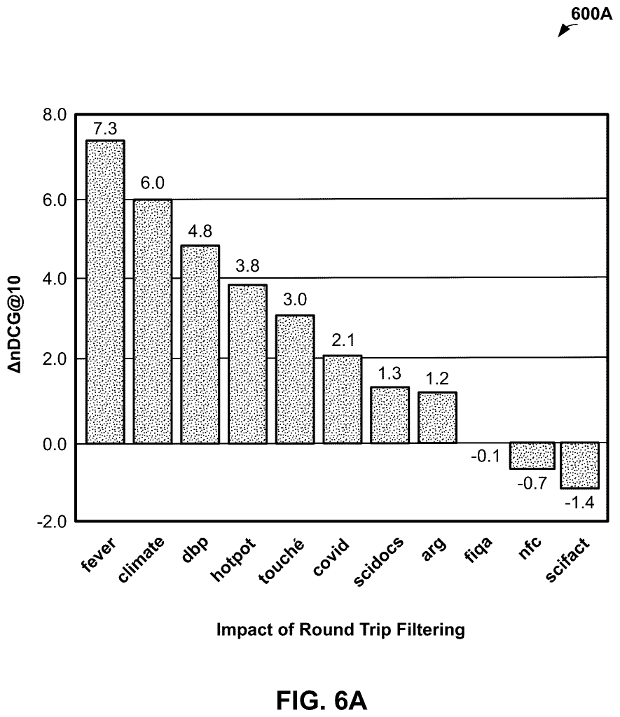

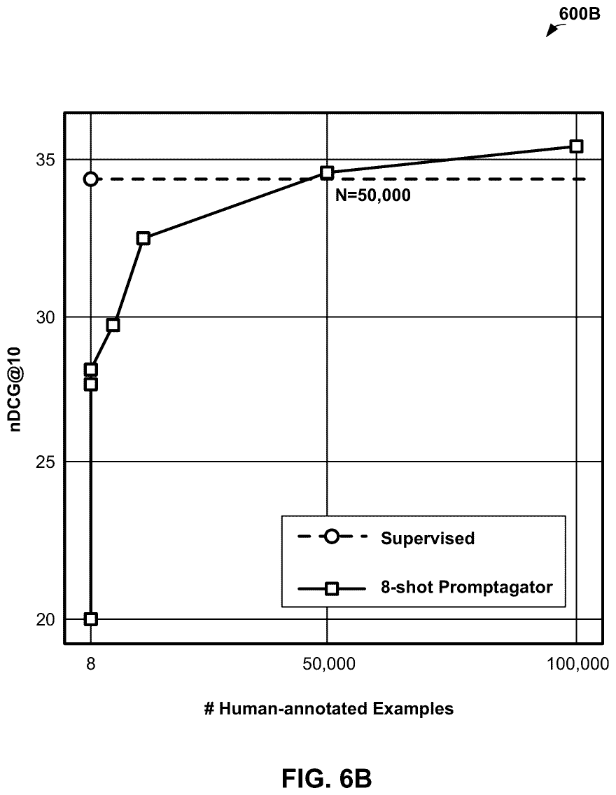

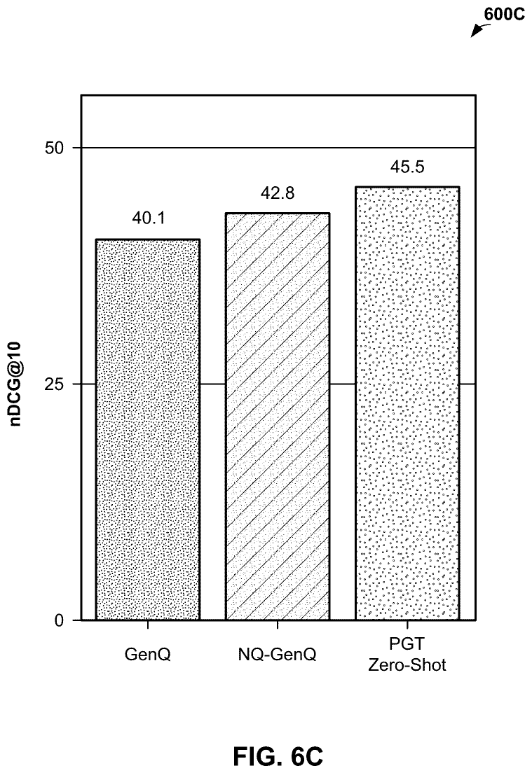

Round-trip filtering 240 may be effective for synthetic question generation on QA tasks. However, existing techniques typically rely on a question-answering model for the reverse direction filter. Since not all retrieval tasks resemble question-answering, such existing approaches may not suffice. Instead, at step train 250, training may be applied to an initial retriever (e.g., a small dual encoder) from the unfiltered synthetic data (e.g., synthetic data 220). The trained initial retriever (e.g., a trained small dual encoder) may then be used to filter the synthetic data. Generally, such an approach works well over the different search intents observed in BEIR. More precisely, given a synthetic query-document pair (q, d), the initial retriever (e.g., trained small dual encoder 210) may be used to predict the most relevant passages for q. The generated query q is selected when d occurs among the Top-K passages returned by the retriever. Such a filter may substantially reduce the number of synthetic queries and can significantly improve retrieval performance. FIGS. 6A-C (to be described later) illustrate examples of queries from few-shot PROMPTAGATOR that were removed by round-trip filtering.

### Round-Trip Filtering as Latent Variable Modeling

In some embodiments, round-trip filtering 240 may involve viewing queries as latent variables that are estimated. Consider a hypothetical graphical model in which each query q is a latent variable and the documents retrieved for that query are observed variables following some distribution, p(d|q, θ*), where θ* represents the parameters of a hypothetical “optimal” retriever that can select the “best” documents for a query. For synthetic data generation, queries may be sampled from the posterior, p(q|d, θ*), which according to Bayes rule may be given as:

$$p ( q \vert d , {θ}^{*} ) = \frac{p ( d \vert q , {θ}^{*} ) p ( q \vert {θ}^{*} )}{{\sum }_{q ′} p ( d \vert {q}^{′} , {θ}^{*} ) p ( {q}^{′} \vert {θ}^{*} )} \qquad ( Eqn . 3 )$$

where p(q|θ*) is a prior over queries. In some aspects, it may be assumed that p(q|θ*) is an “uninformative prior” that is uniform over all q. In terms of notation, p(q|θ*) may be denoted as p(q). When θ*, the parameters of an optimal retriever, are known, the expression in Eqn. 3 may be directly computed. However, θ* is generally an unknown variable, and accordingly, the variable θ may be estimated using expectation maximization (EM). Generally, the round-trip filtering algorithm described herein is a version of EM. EM and other latent variable learning methods may be used to impute missing data.

In EM, the variable θ may be estimated by approximately maximizing a marginal likelihood of the observed variables, as described by the following relationship:

$$\hat{θ} = {arg max}_{θ} {\prod }_{d ∈ {𝒟}_{T}} p ( d ) = {\prod }_{d ∈ {𝒟}_{T}} {\sum }_{q} p ( d \vert q , θ ) p ( q ) \qquad ( Eqn . 4 )$$

For example, in EM, an initial estimate of p(q|d) may be made for every document d. In some embodiments, a FLAN query generator may be used as an initial estimate: P_{FLAN} (q|d). The M-step of EM may involve a computation described by the following relationship:

$$\hat{θ} = {arg max}_{θ} {\prod }_{d ∈ {𝒟}_{T}} {\sum }_{q} {p}_{FLAN} ( q \vert d ) p ( d \vert q , θ ) \qquad ( Eqn . 5 )$$

This may be viewed as equivalent to training an initial retriever p(d|q, \hat{θ}) on documents from [symbol] _{T} that have been paired with LLM (e.g., FLAN) generated queries, as described herein. In some embodiments, the E-step of EM may involve estimating p(q|d, θ) for every document d, as described by the following relationship:

$$p ( q \vert d , \hat{θ} ) ∝ p ( d \vert q , \hat{θ} ) p ( q )$$

As indicated by Eqn. 6, the highest probability queries under p(q|d, \hat{θ}) may be the ones with the highest probability of retrieving d using the initial retriever, since p(q) is an uninformative prior that is uniform over all q.

In some embodiments, importance sampling may be used to sample from p(q|d, \hat{θ}). In importance sampling, query q may be sampled from a selected proposal distribution, pₚᵣₒₚ(q|d). The sample may then be weighted by a ratio p(q|d, \hat{θ})/pₚᵣₒₚ(q|d). In some embodiments, the proposal distribution may be selected as P_{FLAN}(q|d). Accordingly, instead of applying importance-weighting to each sample, the filtering procedure described herein may be configured to discard samples with a low value of p(d|q, θ), which is proportional to the numerator in the importance weight described above.

Although such an EM-like procedure may be repeated until convergence, generally a single round of filtering may yield sufficient quality gains. In some aspects, training of a final retriever model may be viewed as another M-step.

### Few-Shot PROMPTAGATOR Retriever

As described herein, the synthetically generated data (e.g., synthetic data 220) is configured to allow training of task-specific neutral retrievers for tasks where in-domain fine-tuning may be challenging due to data scarcity. In some embodiments, a dual encoder 210 retrieval architecture may be used, along with a pretrain-finetune recipe.

For example, pretrain 245 may involve pretraining the retriever (e.g., dual encoder 210). In some embodiments, the pretraining may be performed on C4 with an independent cropping task from Contriever, where two random crops from the same document may be viewed as an artificial positive (query, document) pair and training may involve, at step train 250, a cross-entropy loss over in-batch random negatives. Subsequently, dual encoder 210 may be fine-tuned on (\hat{q}, d) pairs from the prompt-based query generation, with in-batch random negatives. After training (e.g., at step train 250) for a set number of epochs, round-trip filtering 240 may be applied on synthetic data (e.g., in synthetic dataset 220) using this initial dual encoder, and fine-tuning may be continued on the dual encoder 210 on the filtered data.

Some embodiments may involve a modified PROMPTAGATOR, referred to herein as PROMPTAGATOR++. Generally, this may be a reranker (e.g., cross-attention reranker 215) trained on the same synthetic data (e.g., in synthetic dataset 220) generated from the prompt-based QGen. QGen may be configured to refine the retrieved candidates using a slower but more accurate cross-attention reranker 215. The cross-attention reranker 215 may be trained using a cross-entropy loss (e.g., with 31 sampled negatives 255 from top 200 passages retrieved by the PROMPTAGATOR retriever), which approximates the inference time distribution (e.g., reranking top 200 from the retriever).

### Zero-Shot PROMPTAGATOR

In some embodiments, prompt-based query generation may be configured to run in a zero-shot manner, where a zero-shot prompt 260 may be applied irrespective of the target task. For example, the zero-shot prompt 260 may be ‘{d} Read the passage and generate a query.’ Here {d} denotes the document text. A zero-shot PROMPTAGATOR and a zero-shot PROMPTAGATOR++ may be configured by training retrievers (e.g., document retrieval model 145, dual encoder 210) and rerankers (e.g., cross-attention reranker 215) on such data. These models can serve as a baseline to illustrate the benefits of adapting the few-shot prompt to the target task.

Comparison with Existing Approaches

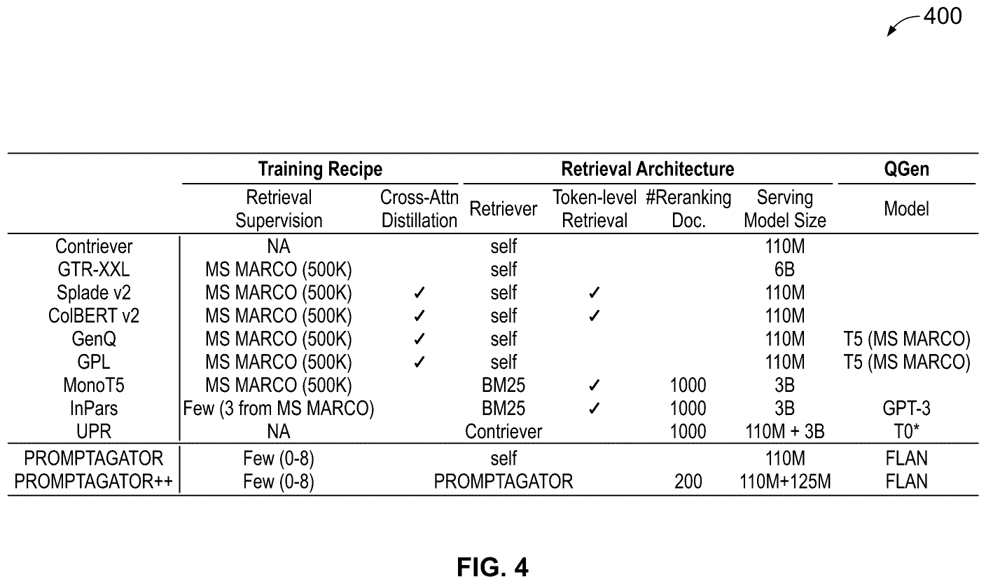

FIG. 4 illustrates example comparisons 400 of different retriever frameworks, in accordance with example embodiments. For example, the setting of PROMPTAGATOR may be compared to some other approaches. Several dimensions of the PROMPTAGATOR approach are simpler than comparative approaches. For example, dual encoder 210 may not rely on hard negative mining, distillation from a cross-attention teacher, and/or token-level retrieval. Also, the reranker, such as cross-attention reranker 215 (e.g., with 125 million parameters), can be configured to be smaller than rerankers in other approaches. In some embodiments, simpler and smaller architectures may be designed to achieve high performance results when trained with synthetic data that has been few-shot adapted, as described herein. Compared to Inquisitive Parrots for Search (InPars) and Unsupervised Pas-sage Re-ranking (UPR) approaches, the PROMPTAGATOR approach employs task-specific few-shot adaption. By contrast, prompts in InPars and UPR are task-independent and thus bear the same limitation of previous query generation approach. Another difference between the approaches is that while existing approaches focus on reranking, the PROMPTAGATOR approach enables few-shot learning for both reranking and retrieval.

### Evaluations

As described herein, the PROMPTAGATOR approach may be evaluated on the BEIR benchmark. Also, for example, ablation studies and qualitative analysis may be performed. In some embodiments, the FLAN training set may overlap with two datasets in BEIR: NQ and Quora. Also, for example, some existing approaches do not report few or zero-shot results on MS MARCO as they use this dataset for fully supervised learning. Accordingly, evaluations may not be based on MS MARCO, NQ, and Quora datasets. Instead, evaluations may be performed on the normalized Discounted Cumulative Gain for 10 items (nDCG@10), the retrieval evaluation metric on BEIR.

For query generation in PROMPTAGATOR, questions may be sampled from FLAN with a given temperature (e.g., 0.7). In some embodiments, setting the filtering threshold K to 1 for round-trip filtering may provide better results on MS MARCO. Accordingly, the filtering threshold K may be set to 1 for all BEIR datasets. In some embodiments, the dual encoders may be implemented based on the Generalizable T5 Retriever (GTR). To ensure efficiency, the T5-base encoder architecture consisting of 110 million parameters may be utilized. For PROMPTAGATOR++ reranking models, a T5-base version 1.1 encoder checkpoint with 125 million parameters may be initialized. In some embodiments, the top 200 candidates retrieved from the PROMPTAGATOR dual encoder may be reranked at inference time.

In some embodiments, the hyperparameters may involve a batch size 6 k; however, some of the corpora in BEIR contain only a few thousand documents, making multiple relevant documents appear in the same batch. This may at times interact negatively with an in-batch softmax loss. Accordingly, datasets may be split into groups based on corpus size, such as, for example, a small group (corpus size <50 k), a medium group (corpus size 50 k-500 k), and a large group (corpus size >500 k). For dual encoder training, a 128 batch size may be used for small datasets and a 6 k batch size may be used for others. Also, for example, 5 k steps may be fine-tuned for large datasets and 1 k for others. For ranking models, a batch size 64 may be used for all datasets and large datasets may be finetuned for 20 k steps, and 5 k steps for others.

### Results

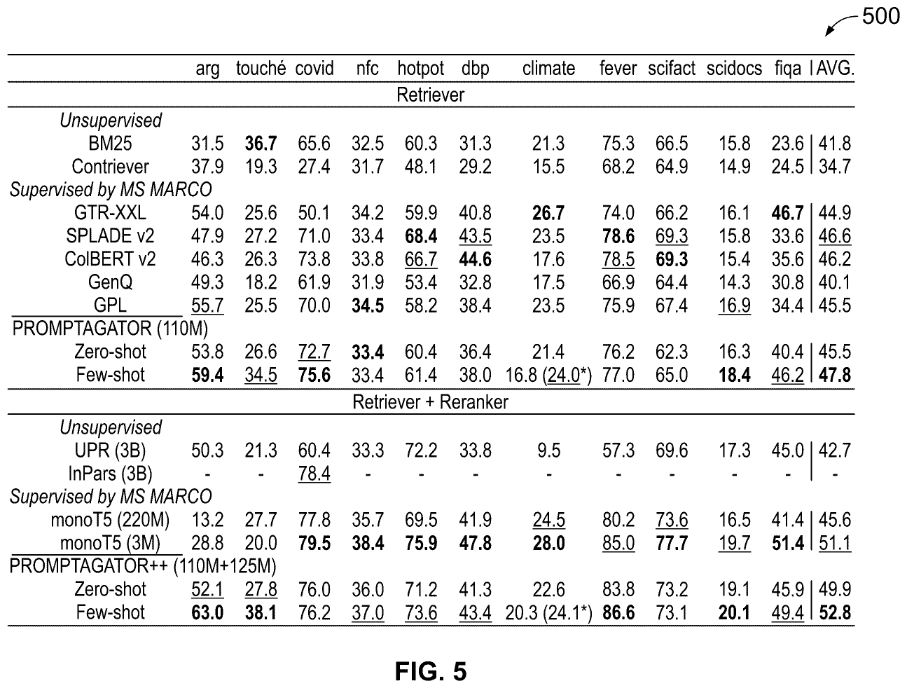

FIG. 5 illustrates example comparisons 500 of different retriever frameworks and retriever with reranker frameworks, in accordance with example embodiments. For example, experimental results are illustrated for such models. As illustrated, the zero-shot PROMPTAGATOR may serve as a strong baseline, comparing favorably to other retrieval baselines trained on [symbol] (100 k) examples from MS MARCO. Also, for example, the few-shot PROMPTAGATOR may significantly improve upon the zero-shot PROMPTAGATOR, increasing average nDCG@10 by over 2 points. This evaluation highlights the impact of few-shot learning. For example, a few-shot PROMPTAGATOR, despite having a simple training procedure and model architecture, can outperform strong baselines such as GenQ and GPL which also use query generation to augment training data, as well as ColBERT v2 and SPLADE v2 which rely on token level interaction architectures and distillation recipes.

As illustrated, the reranker PROMPTAGATOR++ may boost performance by another 5 points on nDCG@10. It may result in a significant improvement over UPR whose reranker uses TO instruction, an instruction tuned LLM similar to FLAN. It may also outperform monoT5-3B, which has previously been shown to achieve previous state-of-the-art reranking performance on BEIR. Existing reranker approaches generally use a large 3 billion parameter model for better generalization, while PROMPTAGATOR++ uses a smaller (e.g., 125) million reranker.

Comparing few-shot PROMPTAGATOR to baselines, a significant improvement may be observed on Webis-Touch62020 (Touche), followed by ArguAna (arg). Webis-Touch62020's goal is to retrieve documents for a controversial topic, such as, for example, “should felons who have completed their sentence be allowed to vote?”. ArguAna's goal is to find the counter-arguments that oppose the input argument, and the input arguments may be several sentences long. Both tasks are generally different from traditional QA retrieval data that other models use, which are dominated by factoid questions. However, few-shot PROMPTAGATOR can successfully adapt to this task with a few examples.

### Impact of Round-Trip Filtering.

FIG. 6A is a bar chart 600A illustrating an impact of round trip filtering, in accordance with example embodiments. In FIG. 6A, quality differences between few-shot PROMPTAGATOR with and without filtering are illustrated. Generally, filtering may improve performance on 8 out of 11 datasets and can result in a 2.5 point improvement on average, demonstrating the effectiveness of a filtering strategy described herein. Although, filtering appears to negatively impact model quality on NFCorpus and SciFact, this may result from a relatively smaller size of these datasets in terms of generated queries, and may indicate overfitting of the retrievers.

Generated Queries v. Human Annotated Queries

FIG. 6B is a graph 600B illustrating human annotated examples, in accordance with example embodiments In FIG. 6B, an 8-shot PROMPTAGATOR is evaluated on MS MARCO, and compared with dual encoders trained on supervised data from MS MARCO. For evaluation purposes, additional components are not added to maintain a simpler comparison. MS MARCO may be selected as there are enough labeled data for this task and neither FLAN nor the models described herein are trained on MS MARCO examples. The results illustrate that eight examples plus an LLM may replace a significant portion of supervised examples.

Comparison with Other Query Generation Approaches

FIG. 6C illustrates results 600C of an example ablation on query generation model, in accordance with example embodiments. FIG. 6C compares zero-shot PROMPTAGATOR to two other query generation approaches: GenQ, a prior system from using a MS MARCO trained T5 query generation model, and natural questions-QGen (NQ-QGen), a T5 QGen model finetuned on NQ. Some advantages of zero-shot PROMPTAGATOR are illustrated, such as, for example, outperforming both baseline models by significant margins. Generally, NQ-QGen uses the same filtering, dual-encoder training, batch sizes, and training steps as PROMPTAGATOR, thereby providing a fair comparison of query generators. The results 600C indicate that a contributing factor to PROMPTAGATOR may be better queries from prompting an LLM, and may not be from a specific training recipe or particular hyperparameters.

### Comparison of Few-Shot and Over Zero-Shot

Referring again to example comparisons 500 of different retriever frameworks and retriever with reranker frameworks in FIG. 5, a few-shot PROMPTAGATOR generally appears to outperform a zero-shot PROMPTAGATOR except for Climate-FEVER. The Climate-FEVER dataset uses one of three tags to annotate a query-document pair, namely “supports”, “refutes”, or “not enough info”. However, BEIR generally views these three annotations as relevant, which may result in undesirable results. Using query-document pairs annotated “not enough info” in a prompt may negatively impact generation quality. Using such pairs in the few-shot prompts may negatively impact query generation. In some evaluations, a few-shot prompt from FEVER may be used as the two datasets share same corpus and similar search intents. Based on such modified annotated examples, a few-shot PROMPTAGATOR appears to outperform a zero-shot PROMPTAGATOR.

### Impact of FLAN Versions

FLAN was trained on a collection of datasets which have some overlap with BEIR; specifically, FLAN includes Natural Questions (NQ) and Quora. However, FLAN was not trained on query-document pairs from NQ or Quora. In order to determine whether the inclusion of this data can bias the results on the final retrieval evaluation, an additional ablation experiment may be designed. For example, based on the FLAN recipe, an additional LLM may be trained by excluding both the NQ and Quora datasets.

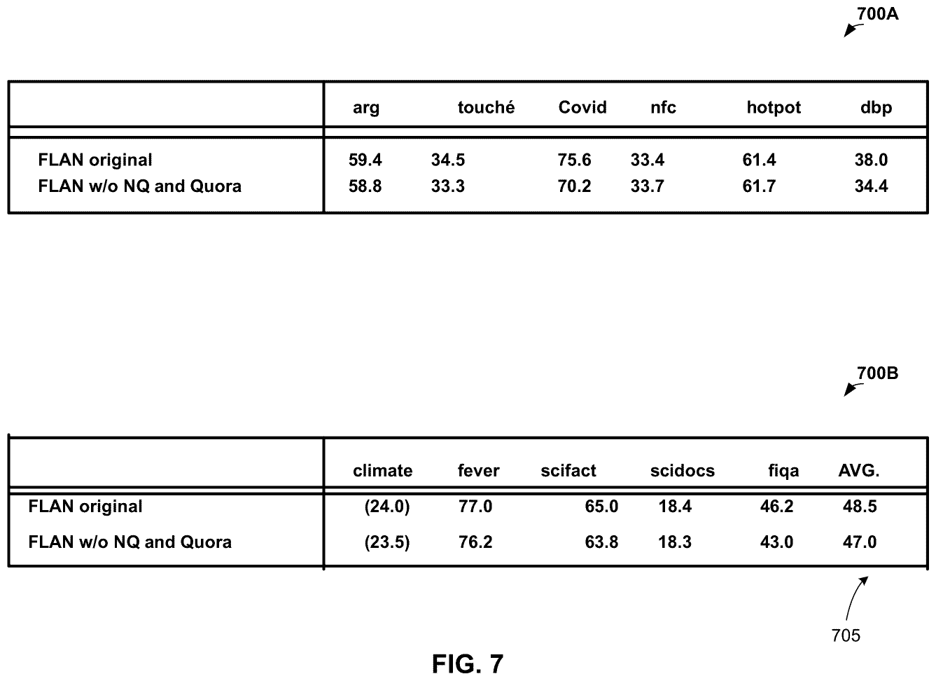

FIG. 7 illustrates an impact of different FLAN versions, in accordance with example embodiments. The results are split into two tables 700a and 700b. The last column 705 in table 700b illustrates an average for the respective rows from tables 700a and 700b. For example, the average value 46.5 in last column 705 is an average of the values in the first rows of tables 700a and 700b. Similarly, the average value 47.0 in last column 705 is an average of the values in the second rows of tables 700a and 700b.

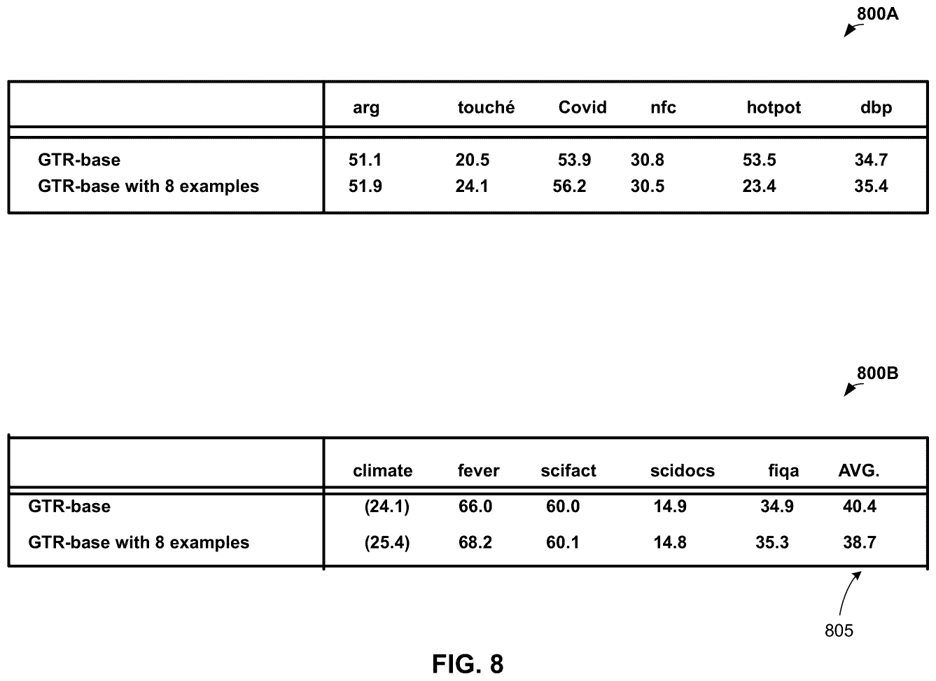

FIG. 8 illustrates an impact of selected examples on model output, in accordance with example embodiments. For example, FIG. 8 illustrates the impact and/or improvement of using eight examples to fine-tune an existing retrieval model (e.g., GTR) Although the accuracy may drop slightly, overall performance outperforms existing retrievers. The results are split into two tables 800A and 800B. The last column 805 in table 800B illustrates an average for the respective rows from tables 800A and 800B. For example, the average value 40.4 in last column 805 is an average of the values in the first rows of tables 800A and 800B. Similarly, the average value 38.7 in last column 805 is an average of the values in the second rows of tables 800A and 800B.

### Qualitative Analysis

Some advantages of a few-shot PROMPTAGATOR may be illustrated based on a distribution of queries generated by different query generation methods for ArguAna. For example, for each distribution, a histogram of each query's first word may be illustrated.

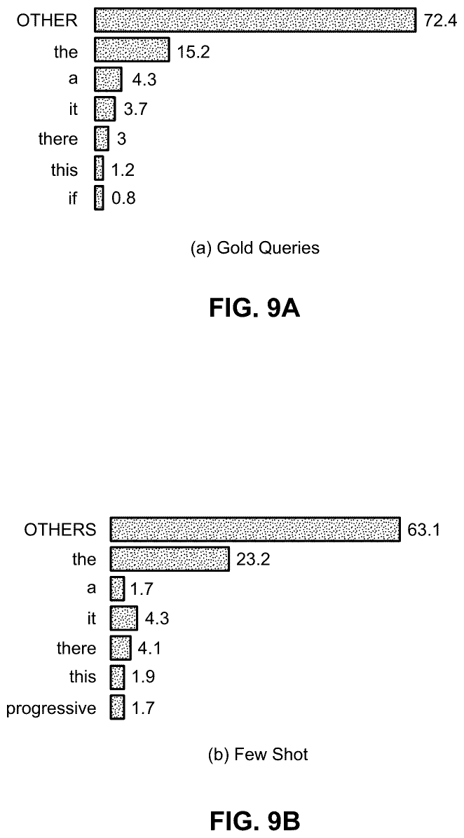

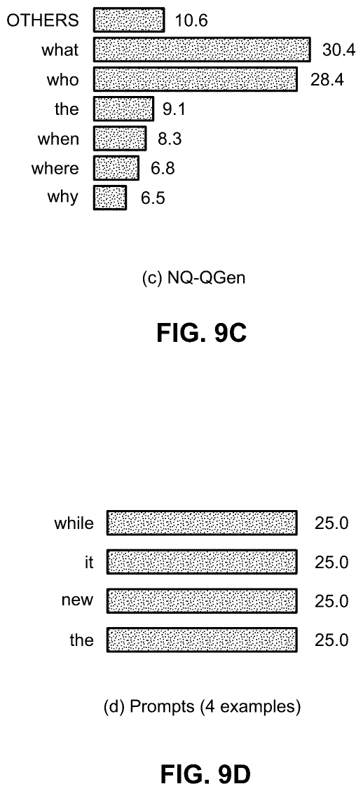

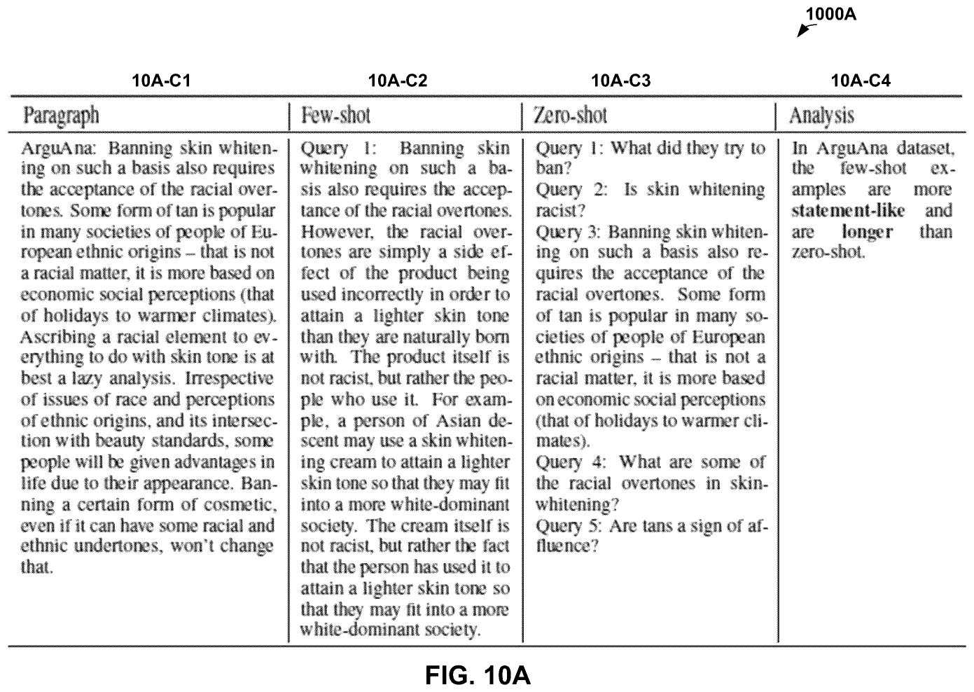

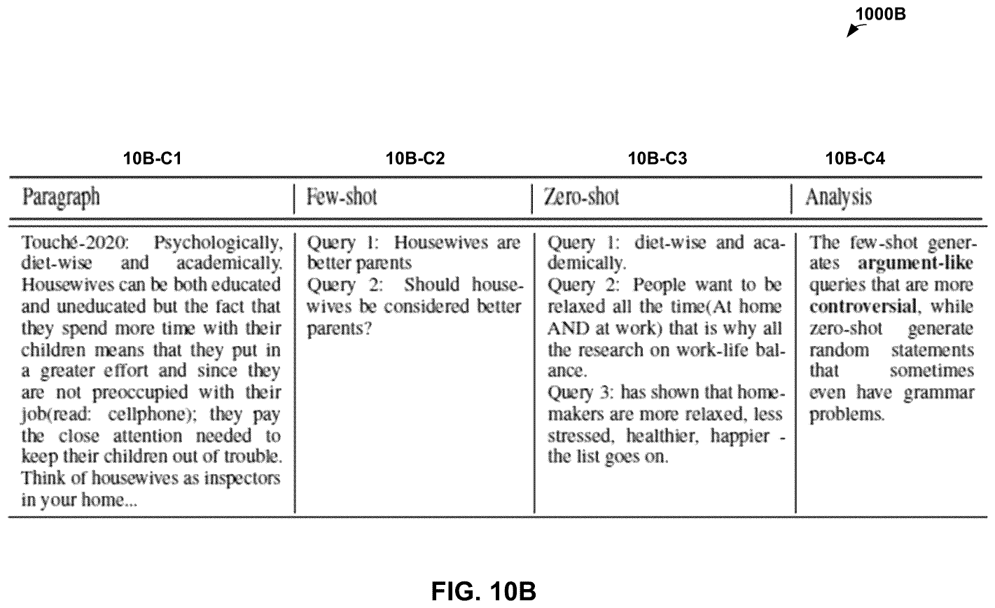

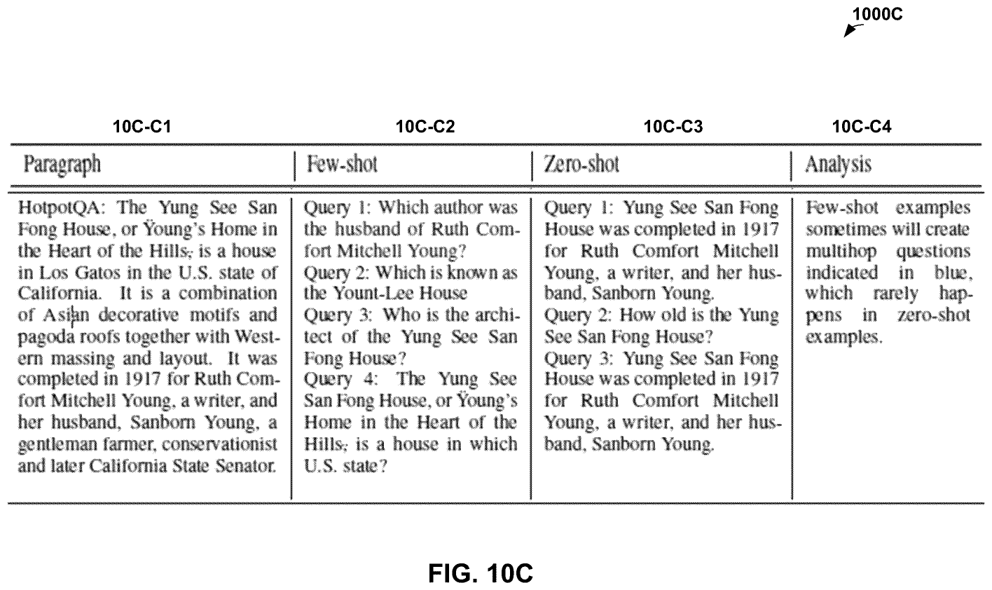

FIGS. 9A-D illustrate example top first word distribution on queries generated from different models in the ArguAna dataset, in accordance with example embodiments. FIG. 9A illustrates a top first word distribution for gold queries. FIG. 9B illustrates a top first word distribution for a few-shot PROMPTAGATOR where the queries are generated. As indicated, the distribution illustrated in FIG. 9B is closer to the real distribution illustrated in FIG. 9A. FIG. 9C illustrates a top first word distribution for NQ-QGen where the queries are generated. NQ-QGen largely generates questions even when the queries in this task are generally arguments, not questions. FIG. 9D illustrates that the few shot FLAN can generate diverse queries even though there are only 4 examples in the prompt. Additional examples are showcased in FIGS. 10A-C.

FIGS. 10A-C illustrate example few-shot and zero-shot generated queries randomly sampled from various datasets, in accordance with example embodiments. Generally, the few-shot generated queries appear to be closer to the original queries, while zero-shot queries appear to be mostly questions. For example, in the ArguAna dataset, the few-shot queries are in general longer and more claim-like. Also, for example, the zero-shot queries are generally short question-like queries. For the HotpotQA dataset, even though both few-shot and zero-shot queries appear to be generating question-like queries, few-shot queries appear to generate multi-hop questions, while zero-shot appear to generate single-hop questions.

Referring to FIG. 10A, column 10A-C1 illustrates an example paragraph, column 10A-C2 illustrates a query generated by a few-shot process, column 10A-C3 illustrates a query generated by a zero-shot process, and column 10A-C4 illustrates an analysis indicating that in the ArguAna dataset, the few-shot generated queries are more statement-like and longer than the zero-shot generated queries.

Referring to FIG. 10B, column 10B-C1 illustrates an example paragraph, column 10B-C2 illustrates a query generated by a few-shot process, column 10B-C3 illustrates a query generated by a zero-shot process, and column 10B-C4 illustrates an analysis indicating that in the Touche-2020 dataset, the few-shot generates argument-like queries that are more controversial, while zero-shot generates random statements that may be grammatically incorrect.

Referring to FIG. 10C, column 10C-C1 illustrates an example paragraph, column 10C-C2 illustrates a query generated by a few-shot process, column 10C-C3 illustrates a query generated by a zero-shot process, and column 10C-C4 illustrates an analysis indicating that in the HotpotQA dataset, the few-shot queries may be multihop questions, while zero-shot does not generate multihop questions.

### Direct Use of Few-Shot Examples

Referring again to FIG. 8, an effect of using the few-shot examples directly may be analyzed by fine-tuning task-specific models using the GTR dual encoder (e.g., 110 million) with the few-shot examples illustrated in FIG. 3. As expected, it does not provide a large amount of impact for the GTR base, where the average nDCG decreases from 40.4 to 38.7.

### Query Generation Statistics

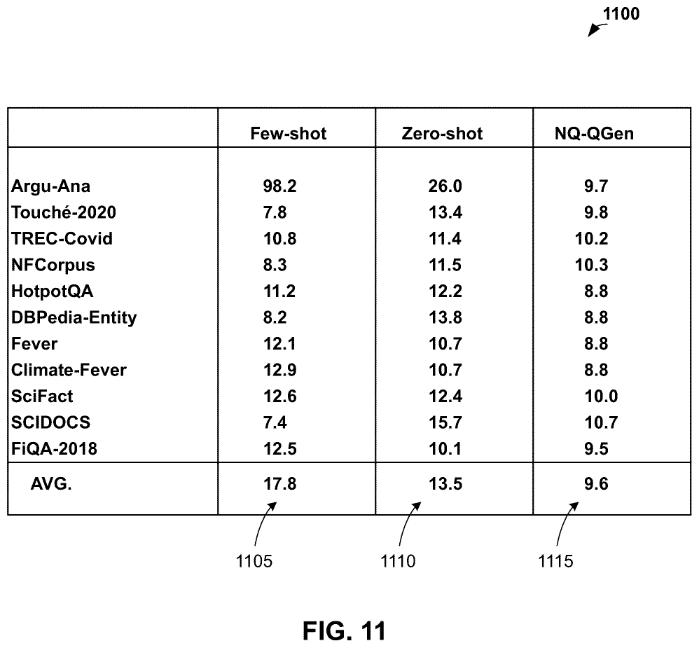

FIG. 11 illustrates a table 1100 with an average query length for various datasets, in accordance with example embodiments. In FIG. 11, the length of the generated questions by different query generation systems is analyzed. NQ-QGen appears to generate short queries due to the query generation models being fine-tuned on the NQ dataset, and the generated questions appear to have similar length to those questions of NQ. Average value 1115 for NQ-QGen is shown as 9.6. However, the zero-shot PROMPTAGATOR appears to obtain higher variance in terms of length compared to NQ-QGen. Average value 1110 for the zero-shot PROMPTAGATOR is shown as 13.5. Also, for example, the few-shot PROMPTAGATOR appears to provide significantly more variance in terms of the length of generated queries. Average value 1105 for the few-shot PROMPTAGATOR is shown as 17.8.

### Compute Usage and Environmental Impact

In some embodiments, a 137 billion FLAN based on LaMDA may be used. LaMDA may be pretrained on a large corpus consisting of 1.56 trillion words, costing 451 mega watt-hours (MWh) energy and a 25.2 tCO2 e carbon footprint. In PROMPTAGATOR, 29.23 million queries*2 prompts=58.46 million queries may be generated, for a total of 610 million words.

### Comparison to Existing Models

Several existing neural retrievers employ a dual encoder architecture that encodes queries and documents independently into dense vectors and retrieves documents using maximum inner product search (MIPS). Existing approaches have primarily focused on the following aspects: developing better pre-training tasks, improving contrastive negatives, and improving generalization across different domains.

Although dual encoders enable fast retrieval, their expressivity may be limited due to the fact that their score is just a dot-product between a query vector and a document vector. A cross-attention model is generally used to rerank retrieved candidates, as cross-attention rerankers can explicitly model the interaction between query and document tokens. Distilling cross-attention models into dual encoders has been effective in closing the gap between the dense retrievers and cross-attention models.

An alternative for bridging the gap between dense retrievers and cross-attention models is to allow some amount of fine-grained query-document interactions in the retriever. For example, queries and documents may be represented and retrieved with multiple vectors instead of a single vector. ColBER, COIL, and SPLADE approaches use token-level interactions between queries and documents. Because these models are not just modeling a dot product, MIPS algorithms cannot be used directly. Hence, these models usually have much higher inference/serving cost compared to dual encoders.

Generally, prompted LLMs may be used for query generation to improve retrieval reranking. For example, UPR uses prompted LLMs to rerank passages directly. InPars uses few-shot prompting with GPT-3 to generate synthetic data for training a T5-based reranker. Though InPars was tested on multiple retrieval datasets, it is based on a task-independent prompt constructed from MS MARCO and does not involve task-specific few-shot learning. InPars is also focused exclusively on reranking, whereas the PROMPTAGATOR approach addresses full-scale retrieval. Pre-trained LLMs have significantly advanced few-shot learning based on prompting strategies such as in-context learning and instruction-prompting. Some approaches involve fine-tuning LLMs specifically for few-shot learning, while others do not. As described herein, the PROMPTAGATOR approach uses LLMs as few-shot data generators.

### Technical Improvements

The techniques described herein allow few-shot retrieval, and the model can achieve significant improvement with just two (2) to eight (8) examples (referred to herein as prompts) for each task. Generally, very few prompts can train the LLM to generate the synthetic data automatically, and these can be used to train the document retrieval model. Existing models attempt to generate the training data directly. The term “prompt” as used herein may be a general one in the zero-shot case, and a task-specific one in the few-shot case. The prompt will be combined with a large language model to produce the queries for the target task using the corpus of documents.

PROMPTAGATOR can achieve good performance with dual encoders without the need for heavily-engineered retrieval architectures. For example, no specialized architectures are needed, and existing large language models may be used.

The techniques described herein can generate queries for retrievers for many diverse targeted tasks.

The retrieval can be performed without a re-ranker.

Prompting with instruction-tuned large language models can address a major limitation of other models that are generally focused on question answering datasets.

The techniques described herein demonstrate that good query generation can boost performance of dual encoders significantly, and as a result, PROMPTAGATOR is significantly more efficient compared to other LLM applications for retrieval.

PROMPTAGATOR-based dual encoders outperform ColBERTv2 and SPLADE v2 on eleven (11) retrieval tasks.

PROMPTAGATOR can steer a LLM to generate text that is tailored to a target task, thus further improving retrieval performance.

Unlike existing few-shot retrieval approaches that are fine-tuned-based and often require thousands of labeled examples, the techniques described herein use a few task specific prompts to synthetically generate the labeled examples.

Zero-shot PROMPTAGATOR generates more varieties in terms of length queries.

A comparison of the distributions of first words of queries generated by different query generation methods indicates that the distribution for synthetic queries generated by few-shot PROMPTAGATOR is much closer to the distribution of real queries generated by humans.

The model has reduced compute usage and environmental impact. For example, the energy cost and carbon footprint for the pretrained models were 451 MWh and 26 tCO2 e, respectively. In some embodiments, the additional instruction tuning gradient-steps for fine tuning FLAN may be less than 2% of the number of pretraining steps, and so the estimated additional energy cost may be comparatively smaller.

Although FLAN is used herein for illustrative purposes, the LLM can be any model, including, but not limited to, T0 or PaLM variants.

### Example Applications

The model may be deployed on a server.

The model may be tailored to a particular type of task, a knowledge domain, a dataset, an organization, and so forth.

In some embodiments, the model may be applied to retrieve documents that support an argument and a counter-argument. For example, the query can be “companies should pay employees at least X,” and the document in the query-document pair can include all posts on a social networking site in support of the query or against the query.

In some embodiments, the model may be applied to perform a semantic search in a database.

Retrieval tasks may be performed in different settings, such as in the financial, medical, educational, legal, and so forth. Many such settings involve data with protected information, and organizations may prefer to not share the protected data. The model may be provided to an organization (e.g., via an application programming interface (API), as a software-as-a-service (SaaS), Machine Learning as a Service (MLaaS), and so forth), and the organization can enter a few prompts to train the model, and apply the trained model, while all the operations are performed, and data remains behind a firewall of the organization.

Retrieval tasks may include question-to-document retrieval, question-to-question retrieval, claim-to-document retrieval, argument-support-document retrieval, or counter-argument-support-document retrieval.

In some embodiments, the task may be retrieval of information from an email system.

The term “document” as used herein generally refers to any information retrieved from the corpus of documents in response to the query. The information retrieved may include a document, a collection of documents, images, portions of images, videos, sound clips, portions of text from one or more documents from the corpus of documents, summaries and/or extracts based on portions of text from one or more documents from the corpus of documents, and so forth. Also, for example, the term “corpus of documents” will generally refer to documents associated with a particular task. For example, the query may be a legal query related to litigation matters for a certain client, and the corpus of documents would correspond to client-specific documents, or more generally, litigation specific documents. As another example, the query may relate to a medical question related to a particular illness, and the corpus of documents would correspond to documents related to the illness or related illnesses. Generally, a user may indicate and/or select the relevant corpus of documents. The corpus of documents can include documents stored in one or more databases (e.g., mobile, desktop, cloud, and so forth), a mail folder, posts on a social networking site, a collection of web pages, a scientific database, images in an image library, videos in a video library, audio, a music library, and so forth. In general, the model may be applied to any collection of data that is configured to be searchable for information, and from which information can be retrieved. This may include textual documents, images, videos, audio files, and so forth. Also, for example, document retrieval may involve speech-to-text transcription.

In some embodiments, the query may relate to an issue to be searched for. For example, a query to an email folder may state “find the information related to the dispute for baggage claim” and the documents retrieved may be one or more emails that were exchanged as part of the dispute process. In some embodiments, the document may be a summary outlining the history of the dispute, with relevant dates and issues. Such a document may be prepared based on a combination of sentiment analysis, natural language processing (NLP), and so forth.

These and other example applications are contemplated within a scope of this disclosure.

### Training Machine Learning Models for Generating Inferences/Predictions

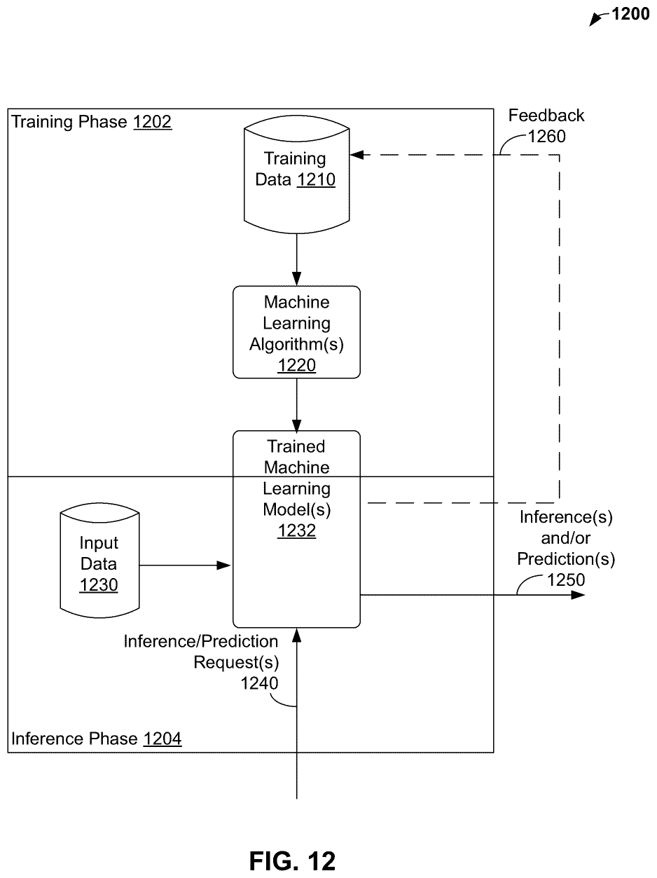

FIG. 12 shows diagram 1200 illustrating a training phase 1202 and an inference phase 1204 of trained machine learning model(s) 1232, in accordance with example embodiments. Some machine learning techniques involve training one or more machine learning algorithms on an input set of training data to recognize patterns in the training data and provide output inferences and/or predictions about (patterns in the) training data. The resulting trained machine learning algorithm can be termed as a trained machine learning model. For example, FIG. 12 shows training phase 1202 where one or more machine learning algorithm(s) 1220 are being trained on training data 1210 to become trained machine learning model(s) 1232. Then, during inference phase 1204, trained machine learning model(s) 1232 can receive input data 1230 and one or more inference/prediction requests 1240 (perhaps as part of input data 1230) and responsively provide as an output one or more inferences and/or prediction(s) 1250.

As such, trained machine learning model(s) 1232 can include one or more models of one or more machine learning algorithm(s) 1220. Machine learning algorithm(s) 1220 may include, but are not limited to: an artificial neural network (e.g., a herein-described convolutional neural networks, a recurrent neural network, a Bayesian network, a hidden Markov model, a Markov decision process, a logistic regression function, a support vector machine, large language model (LLM), a neural retrieval system, a suitable statistical machine learning algorithm, and/or a heuristic machine learning system). Machine learning algorithm(s) 1220 may be supervised or unsupervised, and may implement any suitable combination of online and offline learning.

In some examples, machine learning algorithm(s) 1220 and/or trained machine learning model(s) 1232 can be accelerated using on-device coprocessors, such as graphic processing units (GPUs), tensor processing units (TPUs), digital signal processors (DSPs), and/or application specific integrated circuits (ASICs). Such on-device coprocessors can be used to speed up machine learning algorithm(s) 1220 and/or trained machine learning model(s) 1232. In some examples, trained machine learning model(s) 1232 can be trained, reside and execute to provide inferences on a particular computing device, and/or otherwise can make inferences for the particular computing device.

During training phase 1202, machine learning algorithm(s) 1220 can be trained by providing at least training data 1210 as training input using unsupervised, supervised, semi-supervised, and/or reinforcement learning techniques. Unsupervised learning involves providing a portion (or all) of training data 1210 to machine learning algorithm(s) 1220 and machine learning algorithm(s) 1220 determining one or more output inferences based on the provided portion (or all) of training data 1210. Supervised learning involves providing a portion of training data 1210 to machine learning algorithm(s) 1220, with machine learning algorithm(s) 1220 determining one or more output inferences based on the provided portion of training data 1210, and the output inference(s) are either accepted or corrected based on correct results associated with training data 1210. In some examples, supervised learning of machine learning algorithm(s) 1220 can be governed by a set of rules and/or a set of labels for the training input, and the set of rules and/or set of labels may be used to correct inferences of machine learning algorithm(s) 1220.

Semi-supervised learning involves having correct results for part, but not all, of training data 1210. During semi-supervised learning, supervised learning is used for a portion of training data 1210 having correct results, and unsupervised learning is used for a portion of training data 1210 not having correct results. Reinforcement learning involves machine learning algorithm(s) 1220 receiving a reward signal regarding a prior inference, where the reward signal can be a numerical value. During reinforcement learning, machine learning algorithm(s) 1220 can output an inference and receive a reward signal in response, where machine learning algorithm(s) 1220 are configured to try to maximize the numerical value of the reward signal. In some examples, reinforcement learning also utilizes a value function that provides a numerical value representing an expected total of the numerical values provided by the reward signal over time. In some examples, machine learning algorithm(s) 1220 and/or trained machine learning model(s) 1232 can be trained using other machine learning techniques, including but not limited to, incremental learning and curriculum learning.

In some examples, machine learning algorithm(s) 1220 and/or trained machine learning model(s) 1232 can use transfer learning techniques. For example, transfer learning techniques can involve trained machine learning model(s) 1232 being pre-trained on one set of data and additionally trained using training data 1210. More particularly, machine learning algorithm(s) 1220 can be pre-trained on data from one or more computing devices and a resulting trained machine learning model provided to computing device CD1, where CD1 is intended to execute the trained machine learning model during inference phase 1204. Then, during training phase 1202, the pre-trained machine learning model can be additionally trained using training data 1210, where training data 1210 can be derived from kernel and non-kernel data of computing device CD1. This further training of the machine learning algorithm(s) 1220 and/or the pre-trained machine learning model using training data 1210 of CD1's data can be performed using either supervised or unsupervised learning. Once machine learning algorithm(s) 1220 and/or the pre-trained machine learning model has been trained on at least training data 1210, training phase 1202 can be completed. The trained resulting machine learning model can be utilized as at least one of trained machine learning model(s) 1232. Training data 1210 can be a plurality of query-document pairs, where each query-document pair includes a synthetically generated query and a document from a corpus of documents.

In particular, once training phase 1202 has been completed, trained machine learning model(s) 1232 can be provided to a computing device, if not already on the computing device. Inference phase 1204 can begin after trained machine learning model(s) 1232 are provided to computing device CD1.

During inference phase 1204, trained machine learning model(s) 1232 can receive input data 1230 and generate and output one or more corresponding inferences and/or prediction(s) 1250 about input data 1230. As such, input data 1230 can be used as an input to trained machine learning model(s) 1232 for providing corresponding inference(s) and/or prediction(s) 1250 to kernel components and non-kernel components. For example, trained machine learning model(s) 1232 can generate inference(s) and/or prediction(s) 1250 in response to one or more inference/prediction requests 1240. In some examples, trained machine learning model(s) 1232 can be executed by a portion of other software. For example, trained machine learning model(s) 1232 can be executed by an inference or prediction daemon to be readily available to provide inferences and/or predictions upon request. Input data 1230 can include data from computing device CD1 executing trained machine learning model(s) 1232 and/or input data from one or more computing devices other than CD1. For example, input data 1230 can include at least two prompts associated with a retrieval task to be performed on a corpus of documents associated with the task. Also, for example, input data 1230 can include an input query associated with a retrieval task to be performed on a corpus of documents associated with the task. Other types of input data are possible as well.

Inference(s) and/or prediction(s) 1250 can include output document, output query-document pairs, numerical values (e.g., retrieval scores), and/or other output data produced by trained machine learning model(s) 1232 operating on input data 1230 (and training data 1210). In some examples, trained machine learning model(s) 1232 can use output inference(s) and/or prediction(s) 1250 as input feedback 460. Trained machine learning model(s) 1232 can also rely on past inferences as inputs for generating new inferences.

A large language model and/or a document retrieval model can be an example of machine learning algorithm(s) 1220. After training, the trained version of the neural network can be an example of trained machine learning model(s) 1232. In this approach, an example of the one or more inference/prediction request(s) 1240 can be a request to respond to the input query and a corresponding example of inferences and/or prediction(s) 1250 can be the predicted document from the corpus of documents that is responsive to the input query.

In some examples, one computing device CD_SOLO can include the trained version of the document retrieval model, perhaps after training. Then, computing device CD_SOLO can receive a request to respond to the input query, and use the trained version of the neural network to predict the document from the corpus of documents that is responsive to the input query.

In some examples, two or more computing devices CD_CLI and CD_SRV can be used to provide the predicted document; e.g., a first computing device CD_CLI can generate and send requests to respond to the input query to a second computing device CD_SRV. Then, CD_SRV can use the trained version of the neural network, to predict the predicted document from the corpus of documents that is responsive to the input query, and respond to the requests from CD_CLI for the predicted document. Then, upon reception of responses to the requests, CD_CLI can provide the requested response to the input query (e.g., using a user interface and/or a display, a printed copy, an electronic communication, etc.).

### Example Data Network

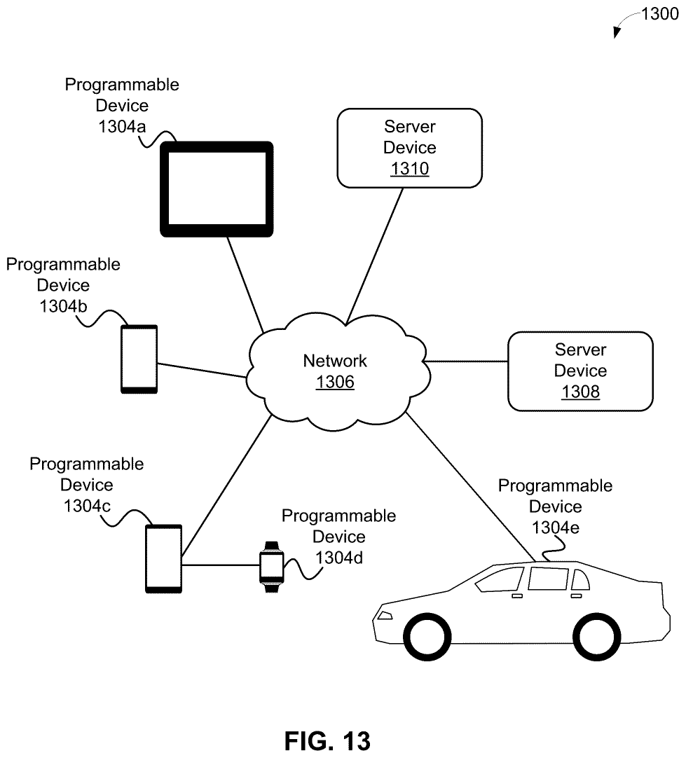

FIG. 13 depicts a distributed computing architecture 1300, in accordance with example embodiments. Distributed computing architecture 1300 includes server devices 1308, 1310 that are configured to communicate, via network 1306, with programmable devices 1304a, 1304b, 1304c, 1304d, 1304e. Network 1306 may correspond to a local area network (LAN), a wide area network (WAN), a WLAN, a WWAN, a corporate intranet, the public Internet, or any other type of network configured to provide a communications path between networked computing devices. Network 1306 may also correspond to a combination of one or more LANs, WANs, corporate intranets, and/or the public Internet.

Although FIG. 13 only shows five programmable devices, distributed application architectures may serve tens, hundreds, or thousands of programmable devices. Moreover, programmable devices 1304a, 1304b, 1304c, 1304d, 1304e (or any additional programmable devices) may be any sort of computing device, such as a mobile computing device, desktop computer, wearable computing device, head-mountable device (TIMD), network terminal, a mobile computing device, and so on. In some examples, such as illustrated by programmable devices 1304a, 1304b, 1304c, 1304e, programmable devices can be directly connected to network 1306. In other examples, such as illustrated by programmable device 1304d, programmable devices can be indirectly connected to network 1306 via an associated computing device, such as programmable device 1304c. In this example, programmable device 1304c can act as an associated computing device to pass electronic communications between programmable device 1304d and network 1306. In other examples, such as illustrated by programmable device 1304e, a computing device can be part of and/or inside a vehicle, such as a car, a truck, a bus, a boat or ship, an airplane, etc. In other examples not shown in FIG. 13, a programmable device can be both directly and indirectly connected to network 1306.

Server devices 1308, 1310 can be configured to perform one or more services, as requested by programmable devices 1304a-1304e. For example, server device 1308 and/or 1310 can provide content to programmable devices 1304a-1304e. The content can include, but is not limited to, web pages, hypertext, scripts, binary data such as compiled software, images, audio, and/or video. The content can include compressed and/or uncompressed content. The content can be encrypted and/or unencrypted. Other types of content are possible as well.

As another example, server device 1308 and/or 1310 can provide programmable devices 1304a-1304e with access to software for database, search, computation, graphical, audio, video, World Wide Web/Internet utilization, and/or other functions. Many other examples of server devices are possible as well.

### Computing Device Architecture

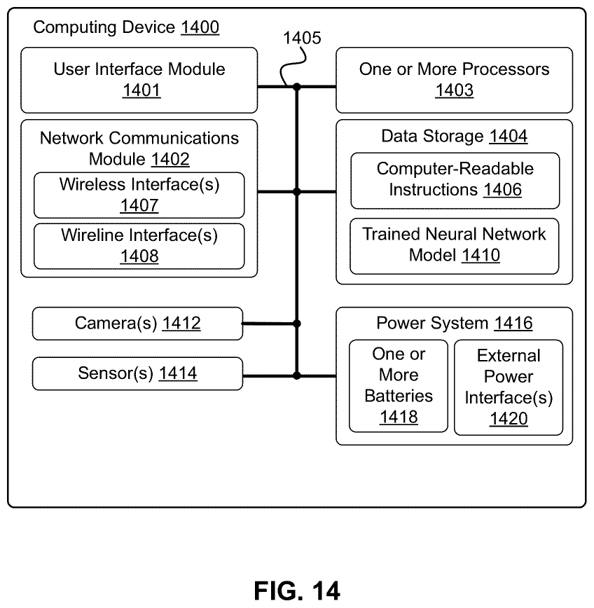

FIG. 14 is a block diagram of an example computing device 1400, in accordance with example embodiments. In particular, computing device 1400 shown in FIG. 14 can be configured to perform at least one function for prompt-based query generation, and/or method 1600, and/or method 1700.

Computing device 1400 may include a user interface module 1401, a network communications module 1402, one or more processors 1403, data storage 1404, one or more camera(s) 1412, one or more sensors 1414, and power system 1416, all of which may be linked together via a system bus, network, or other connection mechanism 1405.

User interface module 1401 can be operable to send data to and/or receive data from external user input/output devices. For example, user interface module 1401 can be configured to send and/or receive data to and/or from user input devices such as a touch screen, a computer mouse, a keyboard, a keypad, a touch pad, a track ball, a joystick, a voice recognition module, and/or other similar devices. User interface module 1401 can also be configured to provide output to user display devices, such as one or more cathode ray tubes (CRT), liquid crystal displays, light emitting diodes (LEDs), displays using digital light processing (DLP) technology, printers, light bulbs, and/or other similar devices, either now known or later developed. User interface module 1401 can also be configured to generate audible outputs, with devices such as a speaker, speaker jack, audio output port, audio output device, earphones, and/or other similar devices. User interface module 1401 can further be configured with one or more haptic devices that can generate haptic outputs, such as vibrations and/or other outputs detectable by touch and/or physical contact with computing device 1400. In some examples, user interface module 1401 can be used to provide a graphical user interface (GUI) for utilizing computing device 1400, such as, for example, a graphical user interface of a mobile phone device. In some examples, user interface module 1401 can be used to provide a user-adjustable control to receive a threshold distance.

Network communications module 1402 can include one or more devices that provide one or more wireless interface(s) 1407 and/or one or more wireline interface(s) 1408 that are configurable to communicate via a network. Wireless interface(s) 1407 can include one or more wireless transmitters, receivers, and/or transceivers, such as a Bluetooth™ transceiver, a Zigbee® transceiver, a Wi-Fi™ transceiver, a WiMAX™ transceiver, an LTE™ transceiver, and/or other type of wireless transceiver configurable to communicate via a wireless network. Wireline interface(s) 1408 can include one or more wireline transmitters, receivers, and/or transceivers, such as an Ethernet transceiver, a Universal Serial Bus (USθ) transceiver, or similar transceiver configurable to communicate via a twisted pair wire, a coaxial cable, a fiber-optic link, or a similar physical connection to a wireline network.

In some examples, network communications module 1402 can be configured to provide reliable, secured, and/or authenticated communications. For each communication described herein, information for facilitating reliable communications (e.g., guaranteed message delivery) can be provided, perhaps as part of a message header and/or footer (e.g., packet/message sequencing information, encapsulation headers and/or footers, size/time information, and transmission verification information such as cyclic redundancy check (CRC) and/or parity check values). Communications can be made secure (e.g., be encoded or encrypted) and/or decrypted/decoded using one or more cryptographic protocols and/or algorithms, such as, but not limited to, Data Encryption Standard (DES), Advanced Encryption Standard (AES), a Rivest-Shamir-Adelman (RSA) algorithm, a Diffie-Hellman algorithm, a secure sockets protocol such as Secure Sockets Layer (SSL) or Transport Layer Security (TLS), and/or Digital Signature Algorithm (DSA). Other cryptographic protocols and/or algorithms can be used as well or in addition to those listed herein to secure (and then decrypt/decode) communications.

One or more processors 1403 can include one or more general purpose processors, and/or one or more special purpose processors (e.g., digital signal processors, tensor processing units (TPUs), graphics processing units (GPUs), application specific integrated circuits, etc.). One or more processors 1403 can be configured to execute computer-readable instructions 1406 that are contained in data storage 1404 and/or other instructions as described herein.

Data storage 1404 can include one or more non-transitory computer-readable storage media that can be read and/or accessed by at least one of one or more processors 1403. The one or more computer-readable storage media can include volatile and/or non-volatile storage components, such as optical, magnetic, organic or other memory or disc storage, which can be integrated in whole or in part with at least one of one or more processors 1403. In some examples, data storage 1404 can be implemented using a single physical device (e.g., one optical, magnetic, organic or other memory or disc storage unit), while in other examples, data storage 1404 can be implemented using two or more physical devices.

Data storage 1404 can include computer-readable instructions 1406 and perhaps additional data. In some examples, data storage 1404 can include storage required to perform at least part of the herein-described methods, scenarios, and techniques and/or at least part of the functionality of the herein-described devices and networks. In some examples, data storage 1404 can include storage for a trained neural network model 1410 (e.g., a model of trained neural networks such as a large language model, a dual encoder, and so forth). In particular of these examples, computer-readable instructions 1406 can include instructions that, when executed by one or more processors 1403, enable computing device 1400 to provide for some or all of the functionality of trained neural network model 1410.

In some examples, computing device 1400 can include one or more camera(s) 1412. Camera(s) 1412 can include one or more image capture devices, such as still and/or video cameras, equipped to capture light and record the captured light in one or more images; that is, camera(s) 1412 can generate image(s) of captured light. The one or more images can be one or more still images and/or one or more images utilized in video imagery. Camera(s) 1412 can capture light and/or electromagnetic radiation emitted as visible light, infrared radiation, ultraviolet light, and/or as one or more other frequencies of light.

In some examples, computing device 1400 can include one or more sensors 1414. Sensors 1414 can be configured to measure conditions within computing device 1400 and/or conditions in an environment of computing device 1400 and provide data about these conditions. For example, sensors 1414 can include one or more of: (i) sensors for obtaining data about computing device 1400, such as, but not limited to, a thermometer for measuring a temperature of computing device 1400, a battery sensor for measuring power of one or more batteries of power system 1416, and/or other sensors measuring conditions of computing device 1400; (ii) an identification sensor to identify other objects and/or devices, such as, but not limited to, a Radio Frequency Identification (RFID) reader, proximity sensor, one-dimensional barcode reader, two-dimensional barcode (e.g., Quick Response (QR) code) reader, and a laser tracker, where the identification sensors can be configured to read identifiers, such as RFID tags, barcodes, QR codes, and/or other devices and/or object configured to be read and provide at least identifying information; (iii) sensors to measure locations and/or movements of computing device 1400, such as, but not limited to, a tilt sensor, a gyroscope, an accelerometer, a Doppler sensor, a GPS device, a sonar sensor, a radar device, a laser-displacement sensor, and a compass; (iv) an environmental sensor to obtain data indicative of an environment of computing device 1400, such as, but not limited to, an infrared sensor, an optical sensor, a light sensor, a biosensor, a capacitive sensor, a touch sensor, a temperature sensor, a wireless sensor, a radio sensor, a movement sensor, a microphone, a sound sensor, an ultrasound sensor and/or a smoke sensor; and/or (v) a force sensor to measure one or more forces (e.g., inertial forces and/or G-forces) acting about computing device 1400, such as, but not limited to one or more sensors that measure: forces in one or more dimensions, torque, ground force, friction, and/or a zero moment point (ZMP) sensor that identifies ZMPs and/or locations of the ZMPs. Many other examples of sensors 1414 are possible as well.

Power system 1416 can include one or more batteries 1418 and/or one or more external power interfaces 1420 for providing electrical power to computing device 1400. Each battery of the one or more batteries 1418 can, when electrically coupled to the computing device 1400, act as a source of stored electrical power for computing device 1400. One or more batteries 1418 of power system 1416 can be configured to be portable. Some or all of one or more batteries 1418 can be readily removable from computing device 1400. In other examples, some or all of one or more batteries 1418 can be internal to computing device 1400, and so may not be readily removable from computing device 1400. Some or all of one or more batteries 1418 can be rechargeable. For example, a rechargeable battery can be recharged via a wired connection between the battery and another power supply, such as by one or more power supplies that are external to computing device 1400 and connected to computing device 1400 via the one or more external power interfaces. In other examples, some or all of one or more batteries 1418 can be non-rechargeable batteries.

One or more external power interfaces 1420 of power system 1416 can include one or more wired-power interfaces, such as a USB cable and/or a power cord, that enable wired electrical power connections to one or more power supplies that are external to computing device 1400. One or more external power interfaces 1420 can include one or more wireless power interfaces, such as a Qi wireless charger, that enable wireless electrical power connections, such as via a Qi wireless charger, to one or more external power supplies. Once an electrical power connection is established to an external power source using one or more external power interfaces 1420, computing device 1400 can draw electrical power from the external power source the established electrical power connection. In some examples, power system 1416 can include related sensors, such as battery sensors associated with the one or more batteries or other types of electrical power sensors.

### Cloud-Based Servers

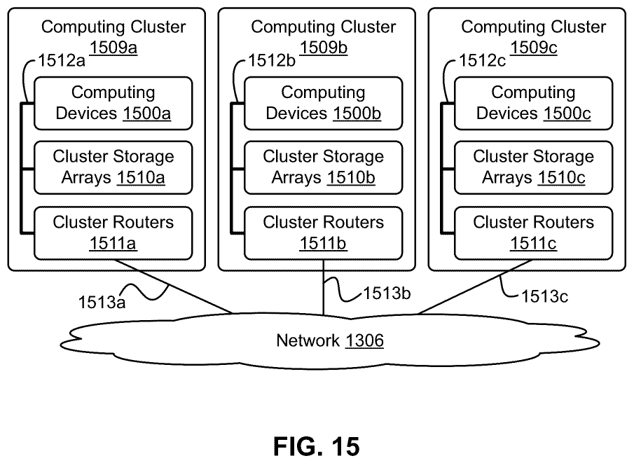

FIG. 15 depicts a cloud-based server system in accordance with an example embodiment. In FIG. 15, functionality of a prompt-based query generation model, a large language model, and/or a document retrieval model can be distributed among computing clusters 1509a, 1509b, 1509c. Computing cluster 1509a can include one or more computing devices 1500a, cluster storage arrays 1510a, and cluster routers 1511a connected by a local cluster network 1512a. Similarly, computing cluster 1509b can include one or more computing devices 1500b, cluster storage arrays 1510b, and cluster routers 1511b connected by a local cluster network 1512b. Likewise, computing cluster 1509c can include one or more computing devices 1500c, cluster storage arrays 1510c, and cluster routers 1511c connected by a local cluster network 1512c.

In some embodiments, computing clusters 1509a, 1509b, 1509c can be a single computing device residing in a single computing center. In other embodiments, computing clusters 1509a, 1509b, 1509c can include multiple computing devices in a single computing center, or even multiple computing devices located in multiple computing centers located in diverse geographic locations. For example, FIG. 15 depicts each of computing clusters 1509a, 1509b, 1509c residing in different physical locations.

In some embodiments, data and services at computing clusters 1509a, 1509b, 1509c can be encoded as computer readable information stored in non-transitory, tangible computer readable media (or computer readable storage media) and accessible by other computing devices. In some embodiments, computing clusters 1509a, 1509b, 1509c can be stored on a single disk drive or other tangible storage media, or can be implemented on multiple disk drives or other tangible storage media located at one or more diverse geographic locations.

In some embodiments, each of computing clusters 1509a, 1509b, and 1509c can have an equal number of computing devices, an equal number of cluster storage arrays, and an equal number of cluster routers. In other embodiments, however, each computing cluster can have different numbers of computing devices, different numbers of cluster storage arrays, and different numbers of cluster routers. The number of computing devices, cluster storage arrays, and cluster routers in each computing cluster can depend on the computing task or tasks assigned to each computing cluster.

In computing cluster 1509a, for example, computing devices 1500a can be configured to perform various computing tasks of prompt-based query generation, a large language model, and/or a document retrieval model. In one embodiment, the various functionalities of a neural network, and/or a computing device can be distributed among one or more of computing devices 1500a, 1500b, 1500c. Computing devices 1500b and 1500c in respective computing clusters 1509b and 1509c can be configured similarly to computing devices 1500a in computing cluster 1509a. On the other hand, in some embodiments, computing devices 1500a, 1500b, and 1500c can be configured to perform different functions.

In some embodiments, computing tasks and stored data associated with various computing tasks of prompt-based query generation, a large language model, and/or a document retrieval model can be distributed across computing devices 1500a, 1500b, and 1500c based at least in part on the processing requirements of a neural network, and/or a computing device, the processing capabilities of computing devices 1500a, 1500b, 1500c, the latency of the network links between the computing devices in each computing cluster and between the computing clusters themselves, and/or other factors that can contribute to the cost, speed, fault-tolerance, resiliency, efficiency, and/or other design goals of the overall system architecture.

Cluster storage arrays 1510a, 1510b, 1510c of computing clusters 1509a, 1509b, 1509c can be data storage arrays that include disk array controllers configured to manage read and write access to groups of hard disk drives. The disk array controllers, alone or in conjunction with their respective computing devices, can also be configured to manage backup or redundant copies of the data stored in the cluster storage arrays to protect against disk drive or other cluster storage array failures and/or network failures that prevent one or more computing devices from accessing one or more cluster storage arrays.

Similar to the manner in which the functions of various computing tasks of prompt-based query generation, a large language model, and/or a document retrieval model can be distributed across computing devices 1500a, 1500b, 1500c of computing clusters 1509a, 1509b, 1509c, various active portions and/or backup portions of these components can be distributed across cluster storage arrays 1510a, 1510b, 1510c. For example, some cluster storage arrays can be configured to store one portion of the data of a first layer of a neural network, and/or a computing device, while other cluster storage arrays can store other portion(s) of data of second layer of a neural network, and/or a computing device. Also, for example, some cluster storage arrays can be configured to store the data of an encoder of a neural network, while other cluster storage arrays can store the data of a decoder of a neural network. Additionally, some cluster storage arrays can be configured to store backup versions of data stored in other cluster storage arrays.

Cluster routers 1511a, 1511b, 1511c in computing clusters 1509a, 1509b, 1509c can include networking equipment configured to provide internal and external communications for the computing clusters. For example, cluster routers 1511a in computing cluster 1509a can include one or more internet switching and routing devices configured to provide (i) local area network communications between computing devices 1500a and cluster storage arrays 1510a via local cluster network 1512a, and (ii) wide area network communications between computing cluster 1509a and computing clusters 1509b and 1509c via wide area network link 1513a to network 1306. Cluster routers 1511b and 1511c can include network equipment similar to cluster routers 1511a, and cluster routers 1511b and 1511c can perform similar networking functions for computing clusters 1509b and 1509b that cluster routers 1511a perform for computing cluster 1509a.

In some embodiments, the configuration of cluster routers 1511a, 1511b, 1511c can be based at least in part on the data communication requirements of the computing devices and cluster storage arrays, the data communications capabilities of the network equipment in cluster routers 1511a, 1511b, 1511c, the latency and throughput of local cluster networks 1512a, 1512b, 1512c, the latency, throughput, and cost of wide area network links 1513a, 1513b, 1513c, and/or other factors that can contribute to the cost, speed, fault-tolerance, resiliency, efficiency and/or other design criteria of the moderation system architecture.

### Example Methods of Operation

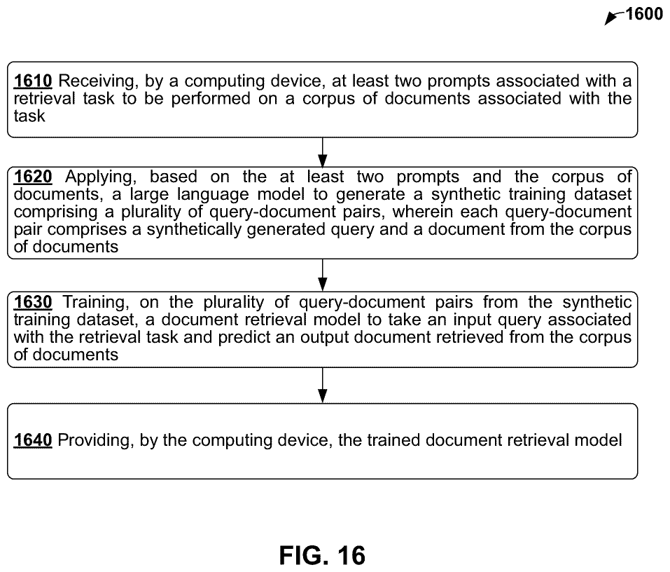

FIG. 16 is a flowchart of a method 1600, in accordance with example embodiments. Method 1600 can be executed by a computing device, such as computing device 1400. Method 1600 for prompt-based query generation can begin at block 1610, where the method involves receiving, by a computing device, at least two prompts associated with a retrieval task to be performed on a corpus of documents associated with the task.

At block 1620, the method involves applying, based on the at least two prompts and the corpus of documents, a large language model to generate a synthetic training dataset comprising a plurality of query-document pairs, wherein each query-document pair comprises a synthetically generated query and a document from the corpus of documents.

At block 1630, the method involves training, on the plurality of query-document pairs from the synthetic training dataset, a document retrieval model to take an input query associated with the retrieval task and predict an output document retrieved from the corpus of documents.

At block 1640, the method involves providing, by the computing device, the trained document retrieval model.

Some embodiments involve determining, by the document retrieval model and for each query-document pair, a retrieval score, wherein the retrieval score is indicative of a relevance of the document of the query-document pair to the query of the query-document pair.

In some embodiments, the document retrieval model may be a dual encoder model comprising a query encoder to encode a query and a document encoder to encode a document.

In some embodiments, the dual encoder model may be a joint embedding model, wherein a query embedding of a given query is within a threshold distance of a document embedding of a given document when the given document has a high relevance to the given query.

In some embodiments, the plurality of query-document pairs may include noisy data. Such embodiments involve filtering the plurality of query-document pairs to remove the noisy data. Such embodiments may involve fine-tuning the document retrieval model based on the plurality of filtered query-document pairs. In some embodiments, the fine-tuning of the document retrieval model may be based on a standard softmax loss with in-batch random negatives.

In some embodiments, the filtering includes one or more of length filtering, prompt filtering, or round-trip filtering.

In some embodiments, the large language model may be a fine-tuned language net (FLAN).

In some embodiments, for each document in the corpus, a query may be sampled based on a distribution comprising a tunable temperature hyperparameter. Such embodiments involve maintaining the temperature hyperparameter below a temperature threshold to generate a diverse array of queries.

In some embodiments, the retrieval task involves one or more of: question-to-document retrieval, a question-to-question retrieval, a claim-to-document retrieval, an argument-support-document retrieval, or a counter-argument-support-document retrieval.

Some embodiments involve pre-training the document retrieval model on unsupervised general-domain data.

In some embodiments, the retrieval task and the corpus of documents may be maintained behind a firewall of an organization. Such embodiments involve providing the large language model and the document retrieval model to the organization. The receiving, applying, and training may be performed behind the firewall of the organization.

In some embodiments, the at least two prompts is less than eight prompts.

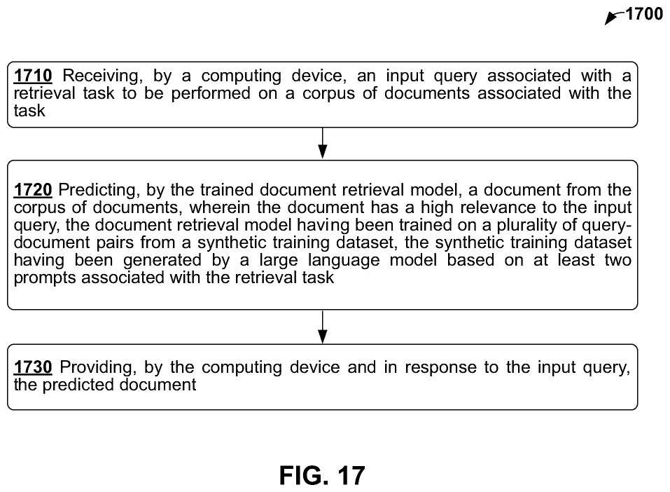

FIG. 17 is a flowchart of a method 1700, in accordance with example embodiments. Method 1700 of applying a trained document retrieval model can be executed by a computing device, such as computing device 1400. Method 1700 can begin at block 1710, where the method involves receiving, by a computing device, an input query associated with a retrieval task to be performed on a corpus of documents associated with the task.

At block 1720, the method involves predicting, by the trained document retrieval model, a document from the corpus of documents, wherein the document has a high relevance to the input query, the document retrieval model having been trained on a plurality of query-document pairs from a synthetic training dataset, the synthetic training dataset having been generated by a large language model based on at least two prompts associated with the retrieval task.

At block 1730, the method involves providing, by the computing device and in response to the input query, the predicted document.

In some embodiments, the document retrieval model may be a dual encoder model comprising a query encoder to encode a query and a document encoder to encode a document.

In some embodiments, the large language model may be a fine-tuned language net (FLAN).

In some embodiments, the retrieval task involves one or more of: question-to-document retrieval, a question-to-question retrieval, a claim-to-document retrieval, an argument-support-document retrieval, or a counter-argument-support-document retrieval.

In some embodiments, the input query may be a voice input, and wherein the retrieval task may be performed by a computer-implemented intelligent voice assistant.

As described herein, PROMPTAGATOR is an approach to few-shot retrieval. It enables training of task-specific retrievers and rerankers with only a few annotated examples. The few-shot examples, amplified by prompt-based LLM query generation, simplifies the complexity of training neural retrievers for new tasks and leads to significant performance gains. PROMPTAGATOR can be viewed as distilling LLM to standard-sized dual encoders via prompt-based query generation. While the distillation process is computationally expensive, it significantly reduces cost for inference.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims.

The above detailed description describes various features and functions of the disclosed systems, devices, and methods with reference to the accompanying figures. In the figures, similar symbols typically identify similar components, unless context dictates otherwise. The illustrative embodiments described in the detailed description, figures, and claims are not meant to be limiting. Other embodiments can be utilized, and other changes can be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

With respect to any or all of the ladder diagrams, scenarios, and flow charts in the figures and as discussed herein, each block and/or communication may represent a processing of information and/or a transmission of information in accordance with example embodiments. Alternative embodiments are included within the scope of these example embodiments. In these alternative embodiments, for example, functions described as blocks, transmissions, communications, requests, responses, and/or messages may be executed out of order from that shown or discussed, including substantially concurrent or in reverse order, depending on the functionality involved. Further, more or fewer blocks and/or functions may be used with any of the ladder diagrams, scenarios, and flow charts discussed herein, and these ladder diagrams, scenarios, and flow charts may be combined with one another, in part or in whole.

A block that represents a processing of information may correspond to circuitry that can be configured to perform the specific logical functions of a herein-described method or technique. Alternatively or additionally, a block that represents a processing of information may correspond to a module, a segment, or a portion of program code (including related data). The program code may include one or more instructions executable by a processor for implementing specific logical functions or actions in the method or technique. The program code and/or related data may be stored on any type of computer readable medium such as a storage device including a disk or hard drive or other storage medium.

The computer readable medium may also include non-transitory computer readable media such as non-transitory computer-readable media that stores data for short periods of time like register memory, processor cache, and random access memory (RAM). The computer readable media may also include non-transitory computer readable media that stores program code and/or data for longer periods of time, such as secondary or persistent long term storage, like read only memory (ROM), optical or magnetic disks, compact-disc read only memory (CD-ROM), for example. The computer readable media may also be any other volatile or non-volatile storage systems. A computer readable medium may be considered a computer readable storage medium, for example, or a tangible storage device.

Moreover, a block that represents one or more information transmissions may correspond to information transmissions between software and/or hardware modules in the same physical device. However, other information transmissions may be between software modules and/or hardware modules in different physical devices.

While various aspects and embodiments have been disclosed herein, other aspects and embodiments will be apparent to those skilled in the art. The various aspects and embodiments disclosed herein are provided for explanatory purposes and are not intended to be limiting, with the true scope being indicated by the following claims.

1. A computer-implemented method for prompt-based query generation, comprising:
receiving, by a computing device, at least two prompts associated with a retrieval task to be performed on a corpus of documents associated with the task;
applying, based on the at least two prompts and the corpus of documents, a large language model to generate a synthetic training dataset comprising a plurality of query-document pairs, wherein each query-document pair comprises a synthetically generated query and a document from the corpus of documents;
training, on the plurality of query-document pairs from the synthetic training dataset, a document retrieval model to take an input query associated with the retrieval task and predict an output document retrieved from the corpus of documents; and
providing, by the computing device, the trained document retrieval model.

2. The computer-implemented method of claim 1, further comprising:
determining, by the document retrieval model and for each query-document pair, a retrieval score, wherein the retrieval score is indicative of a relevance of the document of the query-document pair to the query of the query-document pair.

3. The computer-implemented method of claim 1, wherein the document retrieval model is a dual encoder model comprising a query encoder to encode a query and a document encoder to encode a document.

4. The computer-implemented method of claim 3, wherein the dual encoder model is a joint embedding model, wherein a query embedding of a given query is within a threshold distance of a document embedding of a given document when the given document has a high relevance to the given query.

5. The computer-implemented method of claim 1, wherein the plurality of query-document pairs comprise noisy data, and further comprising:
filtering the plurality of query-document pairs to remove the noisy data.

6. The computer-implemented method of claim 5, further comprising:
fine-tuning the document retrieval model based on the plurality of filtered query-document pairs.

7. The computer-implemented method of claim 6, wherein the fine-tuning of the document retrieval model is based on a standard softmax loss with in-batch random negatives.

8. The computer-implemented method of claim 5, wherein the filtering comprises one or more of length filtering, prompt filtering, or round-trip filtering.

9. The computer-implemented method of claim 1, wherein the large language model is a fine-tuned language net (FLAN).

10. The computer-implemented method of claim 1, wherein for each document in the corpus, a query is sampled based on a distribution comprising a tunable temperature hyperparameter, and further comprising:
maintaining the temperature hyperparameter below a temperature threshold to generate a diverse array of queries.

11. The computer-implemented method of claim 1, wherein the retrieval task comprises one or more of: question-to-document retrieval, a question-to-question retrieval, a claim-to-document retrieval, an argument-support-document retrieval, or a counter-argument-support-document retrieval.

12. The computer-implemented method of claim 1, further comprising:
pre-training the document retrieval model on unsupervised general-domain data.

13. The computer-implemented method of claim 1, wherein the retrieval task and the corpus of documents are maintained behind a firewall of an organization, and further comprising:
providing the large language model and the document retrieval model to the organization, and
wherein the receiving, applying, and training are performed behind the firewall of the organization.

14. The computer-implemented method of claim 1, wherein the at least two prompts is less than eight prompts.

15. A computer-implemented method of applying a trained document retrieval model, comprising:
receiving, by a computing device, an input query associated with a retrieval task to be performed on a corpus of documents associated with the task;
predicting, by the trained document retrieval model, a document from the corpus of documents, wherein the document has a high relevance to the input query, the document retrieval model having been trained on a plurality of query-document pairs from a synthetic training dataset, the synthetic training dataset having been generated by a large language model based on at least two prompts associated with the retrieval task; and
providing, by the computing device and in response to the input query, the predicted document.

16. The computer-implemented method of claim 15, wherein the document retrieval model is a dual encoder model comprising a query encoder to encode a query and a document encoder to encode a document.

17. The computer-implemented method of claim 15, wherein the large language model is a fine-tuned language net (FLAN).

18. The computer-implemented method of claim 15, wherein the retrieval task comprises one or more of: question-to-document retrieval, a question-to-question retrieval, a claim-to-document retrieval, an argument-support-document retrieval, or a counter-argument-support-document retrieval.

19. The computer-implemented method of claim 15, wherein the input query is a voice input, and wherein the retrieval task is performed by a computer-implemented intelligent voice assistant.

20. The computer-implemented method of claim 15, further comprising:
determining, by the computing device, a request to respond to the input query;
sending the request from the computing device to a second computing device, the second computing device comprising a trained version of the document retrieval model;
after sending the request, the computing device receiving, from the second computing device, the predicted document, and
wherein the providing of the predicted document comprises providing the predicted document as received from the second computing device.

21. A computing device, comprising:
one or more processors; and
data storage, wherein the data storage has stored thereon computer-executable instructions that, when executed by the one or more processors, cause the computing device to carry out functions comprising:
receiving, by the computing device, at least two prompts associated with a retrieval task to be performed on a corpus of documents associated with the task;
applying, based on the at least two prompts and the corpus of documents, a large language model to generate a synthetic training dataset comprising a plurality of query-document pairs, wherein each query-document pair comprises a synthetically generated query and a document from the corpus of documents;
training, on the plurality of query-document pairs from the synthetic training dataset, a document retrieval model to take an input query associated with the retrieval task and predict an output document retrieved from the corpus of documents; and
providing, by the computing device, the trained document retrieval model.

22. (canceled)

23. (canceled)

24. (canceled)

25. (canceled)
